(19) United States
(12) Patent Application Publication
(10) Pub. No.: US 2025/0329031 A1
(43) Pub. Date: Oct. 23, 2025

(54) SYSTEMS, METHODS, AND DEVICES FOR FACIAL AND ORAL STATIC AND DYNAMIC ANALYSIS

(71) Applicant: MODJAW, Villeurbanne (FR)

(72) Inventors: Maxime JAISSON, Porte-de-Savoie (FR); Antoine Jules RODRIGUE, Lyon (FR)

(21) Appl. No.: 18/857,776

(22) PCT Filed: Apr. 18, 2023
(86) PCT No.: PCT/IB2023/000240

§ 371 Date: Oct. 17, 2024

Related U.S. Application Data
(60) Provisional application No. 63/363,135, filed on Apr. 18, 2022.

(51) Int. Cl. G06T 7/246; G16H 20/40

(52) U.S. Cl. CPC G06T 7/246; G16H 20/40; G06T 2207/30036

(57) ABSTRACT

This disclosure relates to systems and methods for determining static and dynamic characteristics of a patient. In some embodiments, the systems and methods herein can be used in dental treatment planning. In some embodiments, a method can include receiving, by a computer system, facial scan data of a patient, the facial scan data comprising image data and depth data. A method can include determining, by the computer system based on the facial scan data, a plurality of reference points. A method can include determining, by the computer system, one or more reference points, lines, or planes. A method can including determining, by the computer system, one or more ratios relevant for dental treatment planning. A method can include determining, by the computer system, dynamic characteristics.

### INCORPORATION BY REFERENCE TO ANY PRIORITY APPLICATIONS

This application is the U.S. national phase of International Application No. PCT/IB2023/000240 filed Apr. 18, 2023 which designated the U.S. and claims priority to U.S. 63/363,135 filed Apr. 18, 2022, the entire contents of each of which are hereby incorporated by reference.

### BACKGROUND

### Field

This application relates to systems, methods, and devices that can be used to aid in dental diagnosis and treatment. Some embodiments relate to capturing and manipulating three dimensional images of a patient. Some embodiments relate to capturing or tracking teeth movement after alignment with the patient's face. Some embodiments relate to three-dimensional modeling of a patient's face.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Proper placement of a patient's own teeth, artificial teeth, or both can be important for both aesthetic and functional reasons. often, when a dental practitioner is planning or performing an orthodontic procedure, prosthetic procedure, or both, the practitioner may lack some information that would be helpful to position teeth or to select artificial teeth. Moreover, in some cases, a practitioner may rely on flawed information.

Often, practitioners may rely on limited views of the patient's anatomy that give the practitioner limited insight, causing the practitioner to struggle to account for the overall architecture of the patient and instead focus on the positioning or rearrangement of individual teeth, which can result in poor patient outcomes and/or high costs as treatment may be prolonged.

When developing a treatment plan, practitioners often consider both the positioning of the patient's teeth with respect to one another (which can be obtained using, for example, dental molds or an intraoral scanner) as well as information about the patient's facial structure, such as the location of certain features of the patient's skull, and the positioning of the teeth within the skull. However, collecting such information can be time-consuming, uncomfortable, and prone to errors. Various mechanical, electronic, electromechanical, optical, opto-mechanical, and radiographic devices and methods have been developed, but using them can be cumbersome. Difficulty in using such devices and methods can result in errors and patient outcomes can vary considerably based on the skill of the practitioner in using such devices and methods.

### SUMMARY

For purposes of this summary, certain aspects, advantages, and novel features are described herein. It is to be understood that not necessarily all such advantages may be achieved in accordance with any particular embodiment. Thus, for example, those skilled in the art will recognize that the invention may be embodied or carried out in a manner that achieves one advantage or group of advantages as taught herein without necessarily achieving other advantages as may be taught or suggested herein.

In a first aspect, the techniques described herein relate to a method for determining characteristics of a patient including: receiving, by a computer system, facial scan data of a patient, the facial scan data including image data and depth data; determining, by the computer system based on the facial scan data, a plurality of reference points; determining, by the computer system, one or more reference points, lines, or planes; and determining, by the computer system, one or more ratios relevant for dental treatment planning.

In some embodiments of such first aspect, the techniques described herein relate to a method, wherein the plurality of reference points includes at least one of an infraorbital point, a condylar point, a pupillary point, a nose wing point, a subnasal point, a gnathion point, a trichion point, an ophryon point, a gonion point, a pronasal point, an upper lip point, a lower lip point, an ectocanthion point, a tragion point, a cutaneous nasion point, or a summit of a tragus angle.

In some embodiments of such first aspect, the techniques described herein relate to a method, wherein determining the plurality of reference points includes: generating, based on the facial scan data, a low-dimensional representation of a face of the patient; and determining, using a reference point recognition model, one or more reference points.

In some embodiments of such first aspect, the techniques described herein relate to a method, wherein the low-dimensional representation is based on a two-dimensional projection of at least a part of the facial scan data.

In some embodiments of such first aspect, the techniques described herein relate to a method, wherein the low-dimensional representation is based on the depth data.

In some embodiments of such first aspect, the techniques described herein relate to a method, wherein the low-dimensional representation is based on the image data.

In some embodiments of such first aspect, the techniques described herein relate to a method, wherein determining the plurality of reference points includes: applying, by the computer system, a deformable mask to the facial scan data; and deforming the deformable mask, wherein deforming the deformable mask includes adjusting the deformable mask to reduce a difference between the deformable mask and the facial scan data.

In some embodiments of such first aspect, the techniques described herein relate to a method, wherein the facial scan data includes motion information, wherein the method further includes: determining, by the computer system, dynamic characteristics of the patient.

In some embodiments of such first aspect, the techniques described herein relate to a method, wherein determining the dynamic characteristics includes: detecting, by a motion detection model, movement of a mandible of the patient.

In some embodiments of such first aspect, the techniques described herein relate to a method, further including: receiving, by the computer system, a dental model of the patient; and co-registering the dental model and the facial scan data.

In some embodiments of such first aspect, the techniques described herein relate to a method, wherein the dental model includes a maxillary model and a mandibular model.

In some embodiments of such first aspect, the techniques described herein relate to a method, further including: generating a facial model of the patient; co-registering the dental model and the facial model; and determining a range of motion limit for a mandible of the patient, the range of motion limit determined by determining a closure amount at which the maxillary model collides with the mandibular model.

In some embodiments of such first aspect, the techniques described herein relate to a method, further includes: determining, by the computer system, a condition associated with the patient.

In some embodiments of such first aspect, the techniques described herein relate to a method, wherein generating the low-dimensional representation includes: determining a set of Eigenfaces and a set of associated weights, wherein a face of the patient is described by a linear combination of Eigenfaces and their associated weights.

In some embodiments of such first aspect, the techniques described herein relate to a method, wherein deforming the deformable masks includes one of or more of cage deformation, skeleton animation, or mesh interpolation.

In a second aspect, the techniques described herein relate to a method for determining characteristics of a patient including: receiving, by a computer system, facial scan data of the patient, the facial scan data including image data and depth data; determining, by the computer system, based on the facial scan data, a plurality of reference points; determining, by the computer system, one or more reference points, lines, or planes; and determining, by the computer system, dynamic characteristics of the patient.

In some embodiments of such second aspect, the techniques described herein relate to a method, wherein the plurality of reference points includes at least one of an infraorbital point, a condylar point, a pupillary point, a nose wing point, a subnasal point, a gnathion point, a trichion point, an ophryon point, a gonion point, a pronasal point, an upper lip point, a lower lip point, an ectocanthion point, a tragion point, a cutaneous nasion point, or a summit of a tragus angle.

In some embodiments of such second aspect, the techniques described herein relate to a method, wherein determining the plurality of reference points includes: generating, based on the facial scan data, a low-dimensional representation of a face of the patient; and determining, using a reference point recognition model, one or more reference points.

In some embodiments of such second aspect, the techniques described herein relate to a method, wherein the low-dimensional representation is based on a two-dimensional projection of at least a part of the facial scan data.

In some embodiments of such second aspect, the techniques described herein relate to a method, wherein the low-dimensional representation is based on the depth data.

In some embodiments of such second aspect, the techniques described herein relate to a method, wherein the low-dimensional representation is based on the image data.

In some embodiments of such second aspect, the techniques described herein relate to a method, wherein determining the plurality of reference points includes: applying, by the computer system, a deformable mask to the facial scan data; and deforming the deformable mask, wherein deforming the deformable mask includes adjusting the deformable mask to reduce a difference between the deformable mask and the facial scan data.

In some embodiments of such second aspect, the techniques described herein relate to a method, wherein determining the dynamic characteristics includes: detecting, by a motion detection model, movement of a mandible of the patient.

In some embodiments of such second aspect, the techniques described herein relate to a method, further including: determining a facial model of the patient; receiving a bone model of the patient; and co-registering the bone model and the facial model.

In some embodiments of such second aspect, the techniques described herein relate to a method, further including: determining a contact relation between bones of the bone model.

In some embodiments of such second aspect, the techniques described herein relate to a method, further including: determining a facial model of the patient; receiving a dental model of the patient, the dental model including maxillary teeth and mandibular teeth; and co-registering the dental model and the facial model, wherein co-registering the dental model and the facial model results in an orofacial model.c

In some embodiments of such second aspect, the techniques described herein relate to a method, further including: determining an occlusal surface.

In some embodiments of such second aspect, the techniques described herein relate to a method, further including: determining a functionally generated surface, the functionally generated surface indicating an envelope of function of dental arch motion.

In some embodiments of such second aspect, the techniques described herein relate to a method, further including: determining a hinge axis.

In some embodiments of such second aspect, the techniques described herein relate to a method, further including: determining a condylar slope, the determination based at least in part on a protrusion movement.

In some embodiments of such second aspect, the techniques described herein relate to a method, further including: determining a left Bennett angle, the determination based at least in part on a right laterotrusion.

In some embodiments of such second aspect, the techniques described herein relate to a method, further including: determining a right Bennett angle, the determination based at least in part on a left laterotrusion.

In a third aspect, the techniques described herein relate to a method for training a machine learning model including: receiving a plurality of facial scans associated with a plurality of individuals, the facial scans including image data and depth data, at least one of the facial scans tagged to indicate locations of one or more reference points; generating, for each facial scan of the plurality of facial scans, a low-dimensional representation; providing, to the machine learning model, the generated low-dimensional representations; and training the machine learning model, wherein training the machine learning model includes adjusting one or more weights of the machine learning model.I

In some embodiments of such third aspect, the techniques described herein relate to a method, wherein generating a low-dimensional representation includes computing one or more weights of one or more Eigenfaces.

In some embodiments of such third aspect, the techniques described herein relate to a method, further including, prior to generating the low-dimensional representations: determining, using a different machine learning model, the locations of one or more features to excluded; and removing the one or more features to be excluded, wherein removing includes one or more of blurring or placing a solid object over the one or more features to be excluded.

In some embodiments of such third aspect, the techniques described herein relate to a method, wherein generating the low-dimensional representation includes generating a first two-dimensional representation, the method further including: generating, for each facial scan of the plurality of facial scans, a second two-dimensional representation, the second two-dimensional representation different from the first two-dimensional representation; generating, for each second two-dimensional representation, a second low-dimensional representation; and after training the machine learning model: providing, to a second machine learning model, the second low-dimensional representations; providing, to the second machine learning model, at least one of the one or more weights of the machine learning model; and training the second machine learning model, wherein training the second machine learning model includes adjusting one or more weights of the second machine learning model.

In a fourth aspect, the techniques described herein relate to a system for determining characteristics of a patient including: one or more processors; and a non-volatile storage medium with instructions embodied thereon that, when executed by the one or more processors, cause the system to perform steps of: receiving, by a computer system, facial scan data of a patient, the facial scan data including image data and depth data; determining, by the computer system based on the facial scan data, a plurality of reference points; determining, by the computer system, one or more reference points, lines, or planes; and determining, by the computer system, one or more ratios relevant for dental treatment planning.

In some embodiments of such fourth aspect, the techniques described herein relate to a system, wherein the plurality of reference points includes at least one of an infraorbital point, a condylar point, a pupillary point, a nose wing point, a subnasal point, a gnathion point, a trichion point, an ophryon point, a gonion point, a pronasal point, an upper lip point, a lower lip point, an ectocanthion point, a tragion point, a cutaneous nasion point, or a summit of a tragus angle.

In some embodiments of such fourth aspect, the techniques described herein relate to a system, wherein determining the plurality of reference points includes: generating, based on the facial scan data, a low-dimensional representation of a face of the patient; and determining, using a reference point recognition model, one or more reference points.

In some embodiments of such fourth aspect, the techniques described herein relate to a system, wherein the low-dimensional representation is based on a two-dimensional projection of at least a part of the facial scan data.

In some embodiments of such fourth aspect, the techniques described herein relate to a system, wherein the low-dimensional representation is based on the depth data.

In some embodiments of such fourth aspect, the techniques described herein relate to a system, wherein the low-dimensional representation is based on the image data.

In some embodiments of such fourth aspect, the techniques described herein relate to a system, wherein determining the plurality of reference points includes: applying, by the computer system, a deformable mask to the facial scan data; and deforming the deformable mask, wherein deforming the deformable mask includes adjusting the deformable mask to reduce a difference between the deformable mask and the facial scan data.

In some embodiments of such fourth aspect, the techniques described herein relate to a system, wherein the facial scan data includes motion information, wherein the steps further includes: determining, by the computer system, dynamic characteristics of the patient.

In some embodiments of such fourth aspect, the techniques described herein relate to a system, wherein determining the dynamic characteristics includes: detecting, by a motion detection model, movement of a mandible of the patient.

In some embodiments of such fourth aspect, the techniques described herein relate to a system, wherein the steps further include: receiving, by the computer system, a dental model of the patient; and co-registering the dental model and the facial scan data.

In some embodiments of such fourth aspect, the techniques described herein relate to a system, wherein the dental model includes a maxillary model and a mandibular model.

In some embodiments of such fourth aspect, the techniques described herein relate to a system, wherein the steps further include: generating a facial model of the patient; co-registering the dental model and the facial model; and determining a range of motion limit for a mandible of the patient, the range of motion limit determined by determining a closure amount at which the maxillary model collides with the mandibular model.

In some embodiments of such fourth aspect, the techniques described herein relate to a system, wherein the steps further include: determining, by the computer system, a condition associated with the patient.

In some embodiments of such fourth aspect, the techniques described herein relate to a system, wherein generating the low-dimensional representation includes: determining a set of Eigenfaces and a set of associated weights, wherein a face of the patient is described by a linear combination of Eigenfaces and their associated weights.

In some embodiments of such fourth aspect, the techniques described herein relate to a system, wherein deforming the deformable masks includes one of or more of cage deformation, skeleton animation, or mesh interpolation.

In a fifth aspect, the techniques described herein relate to a system for determining characteristics of a patient including: one or more processors; and a non-volatile storage medium with instructions embodied thereon that, when executed by the one or more processors, cause the system to perform steps of: receiving, by a computer system, facial scan data of the patient, the facial scan data including image data and depth data; determining, by the computer system, based on the facial scan data, a plurality of reference points; determining, by the computer system, one or more reference points, lines, or planes; and determining, by the computer system, dynamic characteristics of the patient.

In some embodiments of such fifth aspect, the techniques described herein relate to a system, wherein the plurality of reference points includes at least one of an infraorbital point, a condylar point, a pupillary point, a nose wing point, a subnasal point, a gnathion point, a trichion point, an ophryon point, a gonion point, a pronasal point, an upper lip point, a lower lip point, an ectocanthion point, a tragion point, a cutaneous nasion point, or a summit of a tragus angle.

In some embodiments of such fifth aspect, the techniques described herein relate to a system, wherein determining the plurality of reference points includes: generating, based on the facial scan data, a low-dimensional representation of a face of the patient; and determining, using a reference point recognition model, one or more reference points.

In some embodiments of such fifth aspect, the techniques described herein relate to a system, wherein the low-dimensional representation is based on a two-dimensional projection of at least a part of the facial scan data.

In some embodiments of such fifth aspect, the techniques described herein relate to a system, wherein the low-dimensional representation is based on the depth data.

In some embodiments of such fifth aspect, the techniques described herein relate to a system, wherein the low-dimensional representation is based on the image data.

In some embodiments of such fifth aspect, the techniques described herein relate to a system, wherein determining the plurality of reference points includes: applying, by the computer system, a deformable mask to the facial scan data; and deforming the deformable mask, wherein deforming the deformable mask includes adjusting the deformable mask to reduce a difference between the deformable mask and the facial scan data.

In some embodiments of such fifth aspect, the techniques described herein relate to a system, wherein determining the dynamic characteristics includes: detecting, by a motion detection model, movement of a mandible of the patient.

In some embodiments of such fifth aspect, the techniques described herein relate to a system, wherein the steps further include: determining a facial model of the patient; receiving a bone model of the patient; and co-registering the bone model and the facial model.

In some embodiments of such fifth aspect, the techniques described herein relate to a system, wherein the steps further include: determining a contact relation between bones of the bone model.

In some embodiments of such fifth aspect, the techniques described herein relate to a system, wherein the steps further include: determining a facial model of the patient; receiving a dental model of the patient, the dental model including maxillary teeth and mandibular teeth; and co-registering the dental model and the facial model, wherein co-registering the dental model and the facial model results in an orofacial model.

In some embodiments of such fifth aspect, the techniques described herein relate to a system, wherein the steps further include: determining an occlusal surface.

In some embodiments of such fifth aspect, the techniques described herein relate to a system, wherein the steps further include: determining a functionally generated surface, the functionally generated surface indicating an envelope of function of dental arch motion.

In some embodiments of such fifth aspect, the techniques described herein relate to a system, wherein the steps further include: determining a hinge axis.

In some embodiments of such fifth aspect, the techniques described herein relate to a system, wherein the steps further include: determining a condylar slope, the determination based at least in part on a protrusion movement.

In some embodiments of such fifth aspect, the techniques described herein relate to a system, wherein the steps further include: determining a left Bennett angle, the determination based at least in part on a right laterotrusion.

In some embodiments of such fifth aspect, the techniques described herein relate to a system, wherein the steps further include: determining a right Bennett angle, the determination based at least in part on a left laterotrusion.

In a sixth aspect, the techniques described herein relate to a system for training a machine learning model including: one or more processors; and a non-volatile storage medium with instructions embodied thereon that, when executed by the one or more processors, cause the system to perform steps of: receiving a plurality of facial scans associated with a plurality of individuals, the facial scans including image data and depth data, at least one of the facial scans tagged to indicate locations of one or more reference points; generating, for each facial scan of the plurality of facial scans, a low-dimensional representation; providing, to the machine learning model, the generated low-dimensional representations; and training the machine learning model, wherein training the machine learning model includes adjusting one or more weights of the machine learning model.

In some embodiments of such sixth aspect, the techniques described herein relate to a system, wherein generating a low-dimensional representation includes computing one or more weights of one or more Eigenfaces.c

In some embodiments of such sixth aspect, the techniques described herein relate to a system, wherein the steps further include, prior to generating the low-dimensional representations: determining, using a different machine learning model, the locations of one or more features to excluded; and removing the one or more features to be excluded, wherein removing includes one or more of blurring or placing a solid object over the one or more features to be excluded.

In some embodiments of such sixth aspect, the techniques described herein relate to a system, wherein generating the low-dimensional representation includes generating a first two-dimensional representation, wherein the steps further include: generating, for each for each facial scan of the plurality of facial scans, a second two-dimensional representation, the second two-dimensional representation different from the first two-dimensional representation; generating, for each second two-dimensional representation, a second low-dimensional representation; and after training the machine learning model: providing, to a second machine learning model, the second low-dimensional representations; providing, to the second machine learning model, at least one of the one or more weights of the machine learning model; and training the second machine learning model, wherein training the second machine learning model includes adjusting one or more weights of the second machine learning model.

All of these embodiments are intended to be within the scope of the present disclosure. These and other embodiments will become readily apparent to those skilled in the art from the following detailed description, having reference to the attached figures, which are incorporated into and form a part of this specification.

### BRIEF DESCRIPTION OF THE DRAWINGS

These and other features, aspects, and advantages of the disclosure are described with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIGS. 1-5 illustrate examples of a patient using a smartphone to capture their face in various poses, such as mouth closed, mouth open, smiling, and so forth, according to some embodiments.

FIG. 6 illustrates an example interface showing a patient from a side view according to some embodiments.

FIG. 7 is an example illustration showing the locations of various primary and secondary points on the face.

FIG. 8 is an illustration that shows the location of selected reference points according to some embodiments.

FIG. 9 is a flow chart for training an artificial intelligence or machine learning model according to some embodiments.

FIG. 10 illustrates an example process for training and using an AI/ML model according to some embodiments.

FIG. 11 illustrates an example of various ratios that can be relevant for dental treatment and planning.

FIG. 12 is a flowchart that illustrates an example process for generating low-dimensional representations according to some embodiments.

FIG. 13 is a flowchart that illustrates an example process according to some embodiments.

FIG. 14 is a flowchart that illustrates an example process according to some embodiments.

FIG. 15A-15B are flowcharts that illustrate an example processes according to some embodiments.

FIGS. 16-17 illustrate example user interfaces according to some embodiments.

FIG. 18 is a block diagram depicting an embodiment of a computer hardware system configured to run software for implementing one or more embodiments disclosed herein.

### DETAILED DESCRIPTION

Embodiments of the disclosure will now be described with reference to the accompanying figures. The terminology used in the description presented herein is not intended to be interpreted in any limited or restrictive manner, simply because it is being utilized in conjunction with a detailed description of embodiments of the disclosure. Furthermore, embodiments of the disclosure may include several novel features, no single one of which is solely responsible for its desirable attributes or essential to practicing the embodiments of the disclosure herein described. For purposes of this disclosure, certain aspects, advantages, and novel features of various embodiments are described herein. It is to be understood that not necessarily all such advantages may be achieved in accordance with any particular embodiment. Thus, for example, those skilled in the art will recognize that one embodiment may be carried out in a manner that achieves one advantage or group of advantages as taught herein without necessarily achieving other advantages as may be taught or suggested herein.

### INTRODUCTION

Proper placement of a patient's own teeth, artificial teeth, or both can be important for both aesthetic and functional reasons. Often, when a dental practitioner is planning or performing an orthodontic or prosthetic procedure, the practitioner may lack some information that would be helpful to position teeth, to select artificial teeth, and so forth. For example, the practitioner may lack information about the patient's jaw motion, the patient's face when performing actions such as smiling or eating, the patient's appearance when viewed from different viewpoints, and so forth. In some cases, practitioners may rely on limited or even incorrect information about the patient, as collecting and accurately representing and manipulating data can be challenging.

In some cases, practitioners may rely on limited views of the patient's anatomy that give the practitioner limited insight, causing the practitioner to struggle to account for the overall architecture and kinematics of the patient and instead focus on the positioning or rearrangement of individual teeth, which can result in poor patient outcomes, prolonged treatment times, increased expense, and so forth.

When developing a treatment plan, practitioners often consider both facial structure and positioning of the patient's teeth, which can be obtained in a variety of manners, such as by collecting dental molds or using an intraoral scanner. Practitioners can consider the patient's facial structure, such as the location of certain features of the patient's skull, the location of the nose, the location of the lips, and so forth. However, collecting such information can be time-consuming, uncomfortable, expensive, and prone to errors. For example, determining the position of the patient's teeth inside the mouth relative to other facial structures can be difficult. With limited information, practitioners may not be able to develop a treatment plan that properly accounts for the patient's skeletal structure, motions, teeth positioning, and so forth.

Various mechanical, electronic, electromechanical, optical, opto-mechanical, and radiographic devices and methods have been developed to aid in dental treatment planning. However, using these devices and methods can be cumbersome. Reconciling data from different sources can be difficult. For example, determining the relative positioning of the teeth and the skull, determining the positioning of teeth relative to lip lines, and so forth can present significant challenges. Difficulty in using such devices and methods can result in errors, and patient outcomes can vary considerably depending upon the skill of the practitioner in using such devices and methods.

In some cases, practitioners can use models (e.g., mechanical models) to represent a patient's morphological and dynamic structure. However, such efforts have generally relied on simple models or average faces, which may fail to accurately reflect the anatomy of an actual patient. To be suitable for dental treatment, it can be important that models represent the patient's actual structural and dynamic characteristics with a high level of accuracy. Without such accuracy, a treatment plan may achieve sub-optimal results.

Accordingly, there is a need for systems and methods that can enable consideration of patient-specific parameters that are easier to use, less prone to errors, and that can give a more complete picture of the patient's static and dynamic structure.

An additional limitation of existing systems and methods can be the high cost of equipment for collecting data. This can present a significant barrier for many practitioners, who may struggle to afford such equipment. The cost to patients can be significant, which can place dental treatment out of reach to some patients. Accordingly, systems and methods that can be implemented at relatively low cost are desirable. Preferably, such systems and methods can be relatively easy to use.

### Facial Data Capture

Preferably, the patient's actual facial structure and jaw movements are considered when formulating a diagnosis, a treatment plan, or both. In some cases, motion capture systems may be used to map the movement of the patient's face (which can include, in some embodiments, the patient's jaw) during actions such as speaking, smiling, eating, drinking, and so forth. The patient's jaw may or may not include the patient's mandibular teeth. In some embodiments, capture of the patient's face can include at least a partial capture of the patient's teeth, although in some other embodiments, the patient's teeth may not be captured during a facial data capture process. In some embodiments, markers can be applied to the patient's face and the movements can be tracked using an infrared camera or other optical tracker. However, some providers may not have access to specialized equipment for facial motion capture. Accordingly, it would be beneficial for providers to be able to capture facial structure and motion without the need for specialized equipment. In some embodiments, only static information may be considered. In some embodiments, only dynamic information may be considered. In some embodiments both dynamic and static information may be considered. Some embodiments described herein can enable data collection using readily available equipment that can be obtained at a low cost as compared with the cost of specialized equipment. For example, in some embodiments, data can be collected using a consumer electronics device such as a smartphone, tablet, or laptop equipped with a depth sensing camera. In some embodiments, an external depth sensing camera can connect to a consumer electronics device, for example via USB.

As consumer imaging hardware has become more advanced, the need for professional or specialized equipment has diminished. For example, imaging systems in smartphones, tablets, laptops, and so forth may have features that allow the capture of depth data. For example, such imaging systems may use structural light, time of flight, stereoscopy, light detection and ranging (LIDAR), or other depth sensing technology. For example, an imaging system may project infrared dots onto the face of a user to determine depth information. Alternatively or additionally, depth may be estimated by, for example, using an infrared emitter and dual cameras, allowing depth to be determined from the stereo disparity between the images captured by each camera. In some cases, stereo cameras that detect in the visible range can be used. Thus, rather than using specialized motion capture cameras and markers, it can be possible to capture the 3D shape and texture of the patient's face using consumer electronics hardware. In some embodiments, the movements of the patient's face can be captured using commonly-available consumer hardware. In some embodiments, a smartphone, tablet, laptop, or the like can be used to capture data about the patient's face and another system, such as a desktop computer or laptop, can be used to work with the captured data. However, in some cases, the data may be manipulated directly on the smartphone, tablet, or other capture device. Advantageously, in some embodiments, such processing can be carried out efficiently due to the presence of specialized integrated circuits, instructions, and so forth available in some consumer hardware. In some embodiments, an application for working with captured data can be written to take advantage of such specialized functionality, although in other embodiments, an application may not take advantage of such specialized functionality. For example, the use of specialized instructions can be avoided if greater device or software compatibility is desired. In some embodiments, different applications can be used depending upon the hardware or software (e.g., operating system) on which the application is to be run. In some embodiments, a single application can be written to take advantage of any acceleration features available while having fallback implementations that can be used when certain features are unavailable.

In some embodiments, the captures of the patient's face and movements can be used in combination with a 3D representation of the patient's teeth (referred to herein as a dental model) as part of a process to determine optimal placement of the teeth. The dental model can be a single model or multiple models (e.g., a maxillary model and a mandibular model). The dental model of the patient's teeth can be obtained in a variety of ways, for example by using an intraoral scanner, by digitizing molds of a patient's teeth, based on cone-beam computed tomography (CBCT) data, and so forth. Dental practitioners typically can have access to at least one of these methods.

In some embodiments, the teeth, gums, or both can be segmented. This may be desirable to facilitate the placement of individual teeth or groups of teeth. In some embodiments, the patient's teeth and gums can be treated separately. In some embodiments, tooth and gum data can be stored in a single file or model. In some embodiments, separate files or models can be used for the gums and for each tooth. In some embodiments, a segment can include multiple teeth, for example two teeth, three teeth, four teeth, and so forth. While in some embodiments, segmentation can be performed, segmentation is not necessary. In some embodiments, segmentation may not be performed.

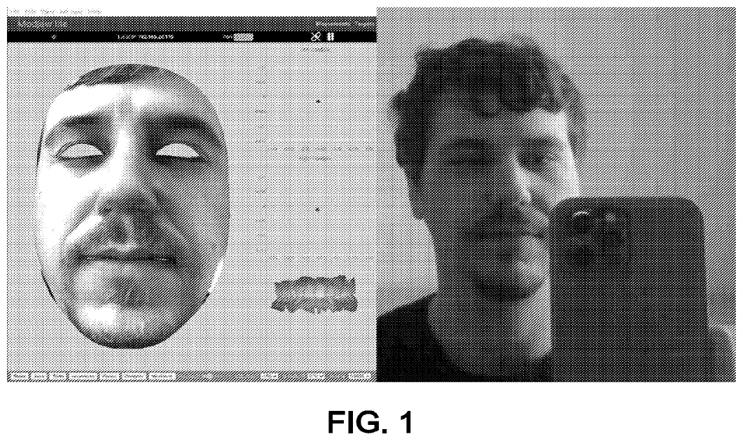

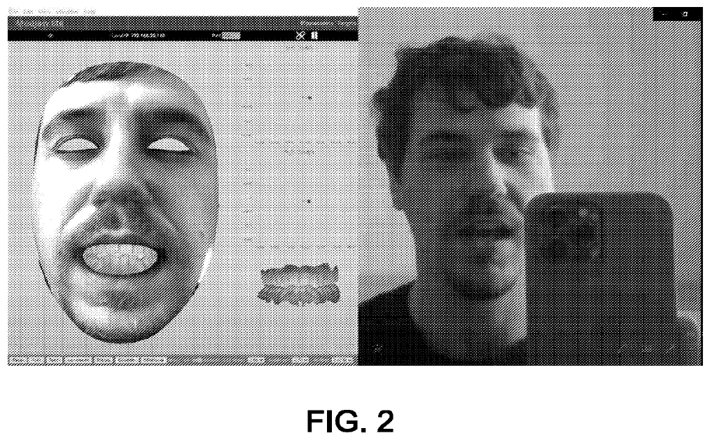

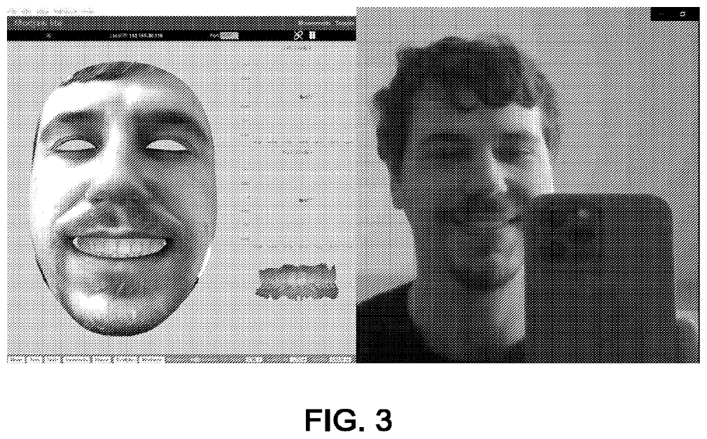

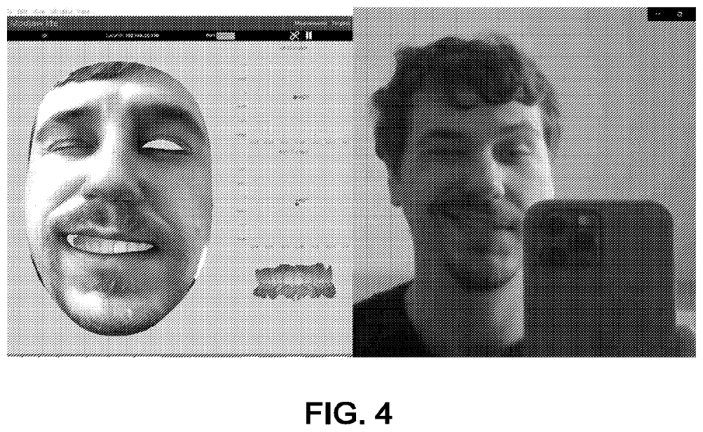

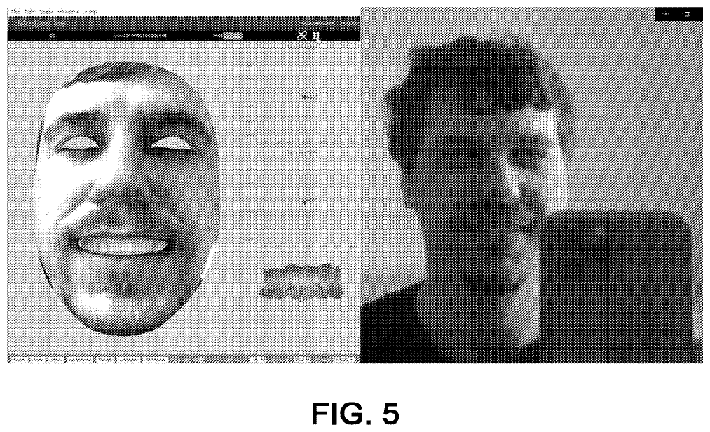

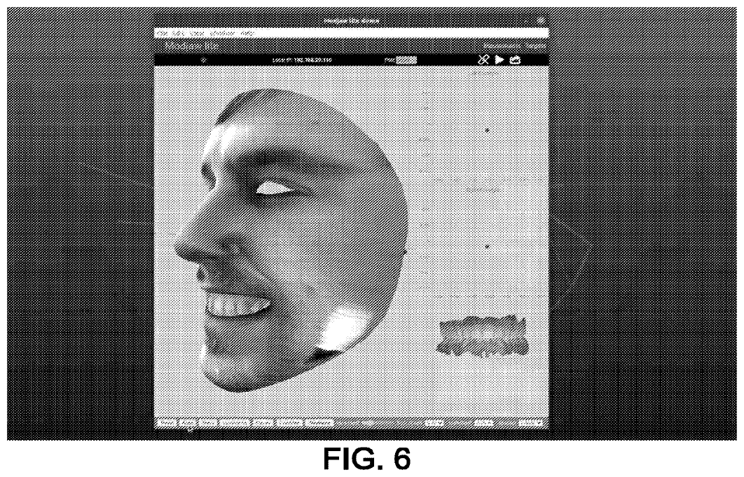

FIGS. 1-5 illustrate examples of a patient using a smartphone to capture their face in various poses, such as mouth closed, mouth open, smiling, and so forth. As shown in FIGS. 1-5, a digital representation of the captured data can be provided in a user interface. As discussed in more detail below, the captured data can be manipulated in various ways and/or can be used as the basis for generating a model that represents the patient's head and teeth (referred to herein as an orofacial model) or a facial model. As shown in FIG. 6, in some captures, the patient may not be facing the camera. For example, the patient can capture side images of the patient's face. In some embodiments, side views can be constructed from frontal images and corresponding depth data. In some embodiments, the patient can capture still photos. In some embodiments, the patient can capture video. In some embodiments, the patient can capture both still photos and video. In some embodiments, captured photos or video can include depth information. In some embodiments, captured photos or videos may not include depth information.

In some embodiments, the patient can capture their own images, videos, facial scans, and so forth, which may or may not include depth information. In some embodiments, a practitioner can capture images, videos, facial scans, and so forth of a patient, which may or may not include depth information. In some embodiments, both the patient and practitioner can both capture images, videos, facial scans, and so forth. In some embodiments, captured image (or video) and depth information can be manipulated, displayed, or both by an application running on a computing system, as described in more detail below.

### Characteristic Determination

As discussed above, determining characteristics of the patient's face, teeth, or both can be important for developing a treatment plan. It can be important to consider both dynamic and static characteristics of the patient's face, although in some embodiments, only dynamic characteristics or only static characteristics may be considered. Consideration of the patient's skeletal structure and motion of the patient's skeleton can be important for both functional and aesthetic reasons, for example to provide a desirable appearance and to avoid premature wear of tooth surfaces.

In some embodiments, the patient's skin texture, the shape of the patient's face, and so forth can be considered in determining a treatment plan. For example, a treatment plan can vary depending on the location of the patient's lips (e.g., how far the lower edge of the top lip is from the bottom of the patient's nose), the shape of the patient's cheeks, and so forth. Patients can have different skin laxity, different levels of buccal fat, and so forth, that can significantly impact a patient's appearance; thus, in some embodiments, the patient's skin can be taken into account when determining a dental treatment plan. Such considerations can be beneficial but are not necessary.

As used herein, “facial scan data” can comprise image data and/or video data captured at least partially in the visible spectrum and their corresponding depth data (e.g., images captured with a depth-sensitive camera of a smartphone or tablet).

### Static Characteristics

Facial scan data can be used to determine the location of various reference points that can be used in developing dental treatment plans. Reference points can include, for example, locations on the patient's head (e.g., location of features of the facial bones, skull, ears, lips, nose, forehead, etc.). In some embodiments, a reference point can be a point on a bone. In some embodiments, a reference point can be a point on soft tissue. In some embodiments, a reference point can be, for example, a joint. In some embodiments, the captured facial data can be used to construct a 3D model of the patient's face. In some embodiments, the captured facial data can be used in conjunction with other data such as radiological data (e.g., x-rays, computed tomography (CT), cone beam computed tomography (CBCT), and so forth). In some embodiments, radiological data can include profile teleradiography data. The use of teleradiography (e.g., radiography with the x-ray source about two meters from the detector or the patient) can be advantageous over some other forms of x-ray data because, for example, it uses relatively parallel x-rays, thereby reducing geometric distortion that can be present in x-ray images captured using non-parallel x-rays. In some embodiments, a profile of the face can be easily determined from a radiological image. In some embodiments, a profile of the face can be determined from the captured facial scan data. In some embodiments, a 3D model can be generated from the facial scan data, as described in more detail herein. In some embodiments, a profile of the face can be determined from the 3D model. In some embodiments, a system can be configured to co-register the profile and the x-ray image data. In some embodiments, registration can be performed in two dimensions. In some embodiments, registration can be performed in three dimensions, for example if 3D CT or CBCT images are used.

In some embodiments, radiological data may not be considered. In some embodiments, radiological data may be considered. For example, radiological data indicating the positions of facial bones can be important for determining bone collisions, movement restrictions, and so forth.

In some embodiments, the positioning of the patient's dental arches with respect to the patient's face can be determined, for example using the systems and methods described in U.S. Pat. No. 10,265,149, entitled “Method and system for modeling the mandibular kinematics of a patient,” the contents of which are incorporated by reference herein in their entirety. In some embodiments, positioning of the patient's dental arches with respect to the patient's face can be determined, for example, using the systems and methods described in U.S. Pub. No. 2022/0156953, filed Mar. 12, 2020, entitled “Method for registering virtual models of the dental arches of an individual with a digital model of the face of said individual,” the contents of which are incorporated by reference herein in their entirety.

In some embodiments, positioning of the patient's teeth can be determined in whole or in part based on data captured during a facial scan. For example, if the patient's teeth are at least partially visible during the facial scan, the facial scan data can be used to determine relative positioning between the patient's teeth and features of the patient's face.

After capturing a facial scan of the patient, the facial scan data can be analyzed for use in determining a dental treatment plan. In some embodiments, as described in more detail herein, a 3D model of the patient's teeth (dental model) can also be used.

In some embodiments, an analysis process can be divided into three phases: an extraction phase, a combination phase, and an analysis phase. In the extraction phase, the facial scan data can be analyzed to determine reference points of interest for dental treatment planning. For example, an algorithm trained or otherwise configured to recognize reference points can be used to identify reference points on one or more images, facial scans, and so forth of a patient. In some embodiments, reference points can be determined directly from the facial scan data. In some embodiments, reference points can be determined indirectly, for example using a low-dimensional representation such as Eigenfaces or Fisherfaces, or using a deformable mask, as described in more detail herein. In the combination phase, subsets of reference points can be associated with each other. In the analysis phase, various calculations, such as angles and distances, can be performed based at least in part on the underlying anatomical features. In some embodiments, more, fewer, or different phases can be used consistent with this disclosure.

The performance of a facial recognition algorithm, AI/ML model, etc., can depend on various factors such as, for example, the resolution, lighting, and so forth of facial scans, images, videos, etc. In some embodiments, the performance of the facial recognition algorithm, AI/ML model, etc., can depend on the compression of images, facial scans, video, etc. For example, highly compressed images may lack detail, leading to less accurate analysis. Other factors can also influence the analysis, such as varying pose of the patient as compared to other images such as training images.

In some embodiments, a 3D scan of the face can be used in combination with a photograph of the patient to improve the analysis. For example, an image processing algorithm can combine information from a facial scan and the photograph of the patient. For example, the photograph can be aligned with features of the facial scan, such as the eyes, nose, lips, hairline, ears, and so forth. In some embodiments, the photograph can be transformed (e.g., resized, rotated, skewed, and so forth) to better fit the facial scan.

### Extraction Phase

As described herein, various approaches can be used for determining reference points, planes, and so forth. In some embodiments, existing approaches to tasks such as facial recognition can be modified for use in dental treatment planning. In some embodiments, artificial intelligence (AI)/machine learning (ML) algorithms can be used. In some embodiments, various approaches can be combined to achieve desired results, as described herein. In some embodiments, deformable masks or the like can be used.

In some embodiments, reference points, planes, axes, landmarks, and so forth can be determined using technology associated with facial recognition, for example as described in U.S. Pat. No. 10,265,149. Facial recognition uses image processing algorithms to identify unique features of a face (e.g., features of a 2D or 3D image or model of a face or a representation of the face such as a low-dimensional representation). In some embodiments, physical features can be extracted in the form of various nodal points which can be used to determine characteristic vectors of the face. Facial recognition algorithms can identify unique biometric and facial characteristics. In some embodiments, particular features can be identified. For example, a facial recognition algorithm can be trained or otherwise configured to identify features such as the nose, mouth, eyes, and so forth. In some embodiments, the facial recognition algorithm can be configured to determine the relative positioning of particular facial features (e.g., distance from nose to mouth, nose to eyes, eyes to mouth, and so forth).

The use of conventional facial recognition algorithms can provide valuable insight. However, such algorithms may not be well-suited to dental treatment applications. For example, a facial recognition algorithm may determine many nodal points on the human face, for example about 80 nodal points. In some cases, a nodal point may correspond directly to a reference point, however this is not necessarily true. In some embodiments, a reference point can be defined relative to one or more nodal points. In some embodiments, a reference point can be determined by, for example, interpolation between nodal points or other estimation methods. In some cases, not all nodal points may be of interest in dental treatment planning, and in some cases, nodal points that are of interest for dental treatment planning may not be identified by conventional facial recognition algorithms. For example, for dental treatment planning, it can be especially important to have a relatively large amount of information relating to the eyes, ears, and/or lips, while points related to some other facial features such as the eyebrows may be of little or no use in dental treatment planning. Accordingly, in some embodiments, facial recognition algorithms can be written or modified such that features of interest for dental treatment are characterized more fully while other features are deemphasized or omitted entirely. Conventional algorithms may fail to include features important for dental treatment. For example, a conventional algorithm may not be suitable for identifying the location of the condylar points, the ophryon, and so forth. Some conventional algorithms may lack information about the overall structure of the face.

Accordingly, there is a need for algorithms that can be used to determine points of interest for dental treatment planning. For example, an algorithm or AI/ML model for facial recognition can be created or modified so that it better identifies features of importance for dental treatment planning than algorithms or AI/ML models conventionally used for facial recognition. In some embodiments, a custom model (e.g., AI/ML model) or algorithm can be created. In some embodiments, an existing model or algorithm can be trained to recognize points of importance for dental treatment planning. In some embodiments, an AI/ML model can be trained to recognize features of the patient's face based directly on the captured facial scan data (e.g., based on images, depth information, or both). This approach can be relatively computationally intensive, as both image data and depth data can comprise a large amount of information but can be relatively simple to implement and can have other advantages such as a relatively large amount of detail which may enable better determination of reference points.

In some embodiments, a low-dimensional representation can enable faster processing. Thus, in some embodiments, it can be beneficial to generate a low-dimensional representation of a patient's face. In some embodiments, a facial recognition algorithm can be used to generate a low-dimensional representation of the patient.

In some embodiments, existing facial recognition algorithms can be used or modified in developing a dental treatment plan. Examples of low-dimensional algorithms can include, for example and without limitation, Fisherface or Eigenface approaches. The Eigenface approach is a conventional approach to facial recognition that uses principal component analysis (PCA). In some embodiments, an algorithm can use Eigenfaces for recognizing faces, features of faces, or both. A set of Eigenfaces can comprise eigenvectors. A set of Eigenfaces can be generated by performing principal component analysis on a set of images of different faces. The Eigenfaces can form a basis set that can be used to represent an arbitrary face, such as the face of a patient. After the Eigenfaces are generated, an image of a particular person can be represented as a linear combination of Eigenfaces. For example, a particular person's face may be represented by a linear combination such as, for example, 0.4EF₁+0.1EF₂+0.3EF₃−0.2EF₄, or more generally ΣᵢwᵢEFᵢ, where EFᵢ represents the ith Eigenface and wᵢ represents the ith weight. It will be appreciated that in practice, there can be any number of Eigenfaces used to represent an individual's face.

In some cases, Eigenfaces can represent particular properties of a person's face, such as symmetry, mouth size, hairline position, and so forth. Other Eigenfaces may not have a clear correspondence to a particular facial feature or metric.

The use of Eigenfaces can reduce computational loads and speed up facial recognition by reducing an image of a person's face to a combination of a relatively small number of eigenvectors. However, in constructing an Eigenface representation of an individual's face, some information can be lost. As discussed above, it can be important to use highly accurate information when developing a dental treatment plan. In some embodiments, information loss can be reduced by using more Eigenfaces to represent the patient's face. For example, instead of 100 eigenvectors, 200, 300, 400, 500, or more can be used. However, this can result in slow performance of a system implementing such an approach and can complicate further analysis. Thus, it can be advantageous to modify a conventional approach such as Eigenfaces or Fisherfaces to be more suited to use for dental treatment planning.

One difficulty associated with using Eigenfaces for dental treatment planning is that the Eigenface approach may not represent the global structure of the face. In some embodiments, similar approaches, such as Fisherfaces, can retain more information about the global structure of the face, which can be important for dental treatment and planning. Fisherfaces can use linear discriminant analysis. As described below, however, it is not necessary that a facial recognition algorithm retain global structure information. For example, Eigenface representations of a patient can be run through an AI/ML model that can determine relevant reference points.

In some embodiments, a modified Eigenface approach can be used that focuses on the features most relevant for dental treatment planning, such as the locations, shapes, sizes, and so forth of the eyes, nose, condylar points, lips, and so forth. For example, Eigenfaces can be used to determine facial points of particular relevance to dental treatment. For example, an Eigenface algorithm can be configured to be suitable for use in identifying the condyles. As one example, in some embodiments, Eigenfaces can be generated using facial images that have irrelevant features blurred or removed (e.g., by cropping, placing solid shapes over irrelevant features, and so forth). Such an approach can help to exclude such features or to limit their influence on an Eigenface representation of a patient. In some embodiments, additional detail related to reference points and other information of particular importance for dental treatment planning can be partially or fully offset by increased losses in representations of other parts of the patient's face. For example, the location of the patient's hairline may not be especially relevant for determining a dental treatment plan, so it is less important that the hairline be represented accurately than other more important features of the patient's face.

In some embodiments, a facial recognition model can be used to pre-process images before determining Eigenfaces. For example, an AI/ML model can be trained using tagged images (e.g., using supervised training) to recognize areas that are of lesser importance for dental treatment planning so that they can be removed or otherwise obscured. In some embodiments, the AI/ML model can output modified images. In some embodiments, the AI/ML model can output the locations of features of lesser importance, and further processing can be performed. For example, using the location information and the corresponding original image, a new image can be produced that obscures the areas of the face that are of lesser importance. In some embodiments, such an AI/ML model can consider both depth and image data, although in some embodiments, only image data or only depth data may be used.

In some embodiments, modular Eigenfaces can be used. As described herein, modular Eigenfaces can be an extension of Eigenfaces that enables processing of images with varying poses, facial expressions, or both. The modular Eigenfaces approach can use sets of Eigenfaces that are generated for each pose, facial expression, or both. For example, one set of Eigenfaces can be generated using images of individuals who are facing the camera with a neutral expression, while another, different set of Eigenfaces can be generated using images of individuals who have their heads tilted to one side while smiling. These are merely examples, and sets of Eigenfaces can be generated using any desirable combination of pose and facial expression, for example using forward-facing and profile images. In some embodiments, a facial expression can be a smile, frown, and so forth, but facial expressions are not so limited. For example, a facial expression can include the appearance of an individual's face while chewing, laughing, speaking, and so forth.

This approach can be especially beneficial in dental treatment planning, as it can be important to ensure that a dental treatment plan will result in desirable aesthetics from a variety of views, under a variety of facial expressions and/or during various actions such as speaking and chewing.

The approaches described above can rely on image information, which can be two-dimensional or three-dimensional. For example, Eigenfaces can be generated from a set of images, and an image of a patient can be described as a linear combination of Eigenfaces. According to some embodiments, the above approaches can be improved or expanded upon by using depth information captured during a facial scanning process. For example, sets of Eigenfaces (or another low-dimensional representation approach) can be generated based at least in part on depth information, and depth information associated with the facial capture of a particular patient can be represented as a linear combination of such Eigenfaces. In some embodiments, further processing as described herein can operate solely on Eigenface representations using image data, solely on Eigenface representations using depth data, or both.

Using the approaches described above, one or more Eigenface representations of a patient can be generated that can be used to more accurately represent features of importance for dental treatment and planning, while limiting the number of Eigenfaces needed to adequately represent patients, which can reduce training time, decrease computational burdens, and so forth.

In some embodiments, the extraction phase can include determining reference points of interest. In some embodiments, the extraction phase can include locating reference points on the patient's face. In some embodiments, reference points can correspond to the locations of anatomical points known in the literature. The locations of some reference points may generally be known to those of skill in the art. However, as anatomical features vary from patient to patient, it can be important not to assume the locations of anatomical points. Some anatomical points may be readily discernable upon visual inspection of the patient. However, some anatomical points may not be visible. For example, the general location of the condyles is known, but their actual positions on an individual patient can vary from the published literature, and the condyles may lack precise visual indicators. Accordingly, in some embodiments, an artificial intelligence or machine learning model can be used to identify reference points. For example, an AI/ML model can be trained using tagged images that indicate the locations of reference points, as described herein.

In some embodiments, reference points can be divided into primary points and secondary points. In some embodiments, a primary point can indicate the location of a reference point of interest. However, in some cases, an artificial intelligence or machine learning (AI/ML) model may struggle to identify a primary point. For example, if a primary point is covered or otherwise obscured by a patient's hair or facial hair or if there are no clear visual indicators, the AI/ML model may not be able to identify the primary point or may misidentify the primary point. Other characteristics of the patient can, alternatively or additionally, make it difficult to identify reference points, such as skin laxity, eyeglasses, piercings, tattoos, cosmetic implants, and so forth. In some embodiments, secondary points can be points that can be used to deduce the location of one or more primary points. A non-exhaustive listing of primary and secondary points can be found in, for example, U.S. Pat. No. 12,265,149, the entire contents of which are incorporated by reference herein for all purposes.

In some embodiments, primary points can include, for example and without limitation:
infraorbital point
condylar point
pupillary point
nose wing point (ala of the nose)
subnasal point
gnathion point
trichion point
ophryon point
gonion point
pronasal point
upper lip point
lower lip point.

The locations of these and other points may be generally known in the literature. However, for dental treatment planning, it can be important to ensure that the points are located accurately for a particular patient.

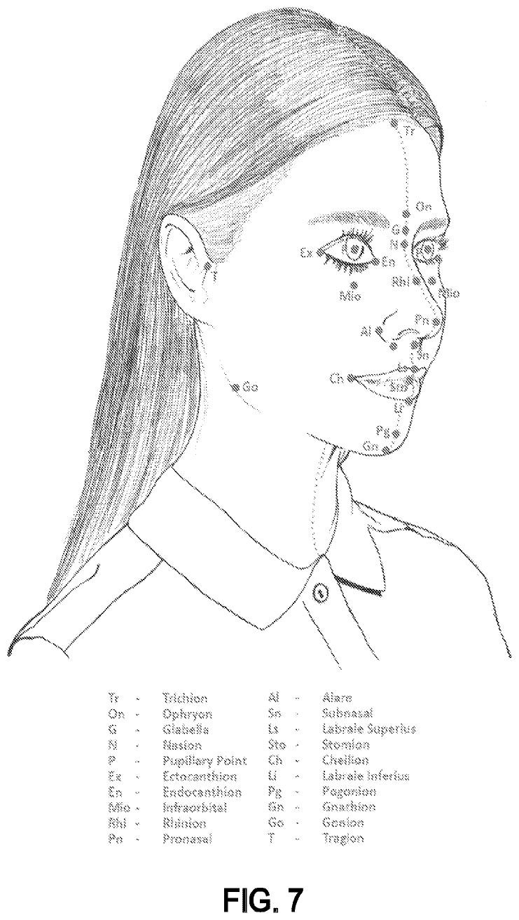

FIG. 7 is an example illustration showing the locations of various primary and secondary points on the face. The dashed line represents the median plane (e.g., the median sagittal plane). It will be appreciated that the points shown in FIG. 7 do not necessarily represent an exhaustive list of primary and secondary points. While FIG. 7 illustrates the general locations of various primary and secondary points, it will be appreciated that the precise positioning of the primary and secondary points can vary to some extent from patient to patient.

In some embodiments, the infraorbital point can be determined in various ways. For example, the infraorbital point can be determined from a 3D scan or 3D model of the face as the most sloping point of the inferior border of the orbit (e.g., the left orbit or the right orbit). In some embodiments, to construct an axis orbital plane, either the left or right infraorbital point can be used. In some embodiments, an average of the left and right infraorbital points can be used. Depending on facial anatomy, it can be difficult to locate the infraorbital point. For example, prominent cheeks may obscure the infraorbital point. Thus, in some embodiments, secondary points can be used. For example, published research indicates that the infraorbital point is typically located about 25.4 mm below the nasion point. However, this is merely a typical value and the actual location on an individual patient may vary. In some embodiments, an AI/ML model can be trained to identify primary points even when those primary points are obscured, for example by considering a patient's overall facial structure and/or other points that can be determined (for example, other primary and/or secondary points). The use of secondary points is described in more detail below.

In some embodiments, condylar points can be determined from secondary points, as described in more detail below. In some embodiments, various definitions of the condylar point can be used. For example, published research indicates that the Duminil condylar point can be 9.5 mm forward (from the tragus angle) and 7.5 mm vertically downward from a straight line formed between the ectocanthion and tragus angle. As noted above with respect to the infraorbital point, this is merely a typical value and can vary from patient to patient. In some embodiments, dynamic data can be used to locate a hinge axis. In some embodiments, the location of the hinge axis can be used to determine the condylar point location. The use of dynamic data is discussed in more detail below. In some embodiments, an AI/ML model can be configured to locate the condylar point in a manner similar to or the same as that described above with respect to the infraorbital point. Other points can similarly be determined, such as Guichet's point, Gysi's point, and/or Monson's point.

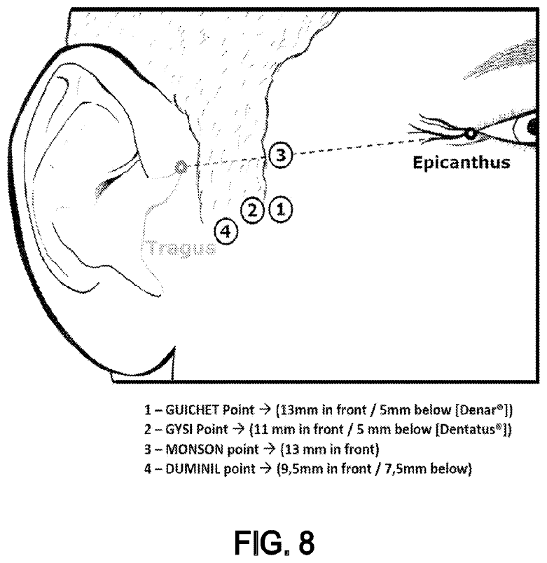

FIG. 8 is an illustration that shows the location of the Guichet point, the Gysi point, the Monson point, and the Duminil point in reference to a line segment extending between the tragus and epicanthus. It will be appreciated that these points can give an approximate location of the condyles. The precise location of the condyles can vary from patient to patient and can be determined more accurately as described herein, for example using an AI/ML model trained to recognize features relevant for dental treatment and planning.

In some embodiments, the pupillary point can be relatively easy to locate. For example, an AI/ML model can be trained to recognize the location of an eye, and the pupillary point can be located in the center of the eye.

In some embodiments, the nose wing point (ala of the nose) can be the point where the nose wing meets the upper lip. There can be two nose wing points, one on the left and one on the right. In some embodiments, an AI/ML model can readily determine the location of a nose wing point, for example due to disturbance in contour lines. In some embodiments, color information, brightness information, and/or the like can be used in determining the location of a nose wing point. For example, the presence of shadows can be used in determining the location of a nose wing point.

In some embodiments, the subnasal point can be located between the two nostrils at the base of the nose. In some embodiments, the subnasal point can be located from the highest and most remote point of the nasolabial notch. In some embodiments, the gnathion point can be the most inferior point of the cutaneous chin. In some embodiments, the trichion point can be located at the anterior hairline. In some embodiments, the ophryon point can be located at the upper edge of the eyebrows. In some embodiments, the gonion point can be located at the mandibular angle. In some embodiments, the pronasal point can be the tip of the nose (e.g., the most forward point of the nose). In some embodiments, the upper lip point can be on the median sagittal line and at the intersection of the upper lip and the facial skin. In some embodiments, the lower lip point can be on the median sagittal line and at the border between the lower lip and the facial skin. In some embodiments, an AI/ML model can be trained to identify some or all of these points. In some embodiments, an AI/ML model can be trained to identify additional points, such as secondary points.

In some embodiments, an AI/ML model can be trained to identify various secondary points. Secondary points can be used, for example, to aid in determining the location of one or more primary points. Secondary points can include, for example and without limitation:
ectocanthion point
tragion point
summit of the tragus angle
cutaneous nasion point.

In some embodiments, the ectocanthion can be defined by a point at which the outer ends of the upper and lower eyelids meet. In some embodiments, the tragion can be the highest point of the tragus of the ear in the sagittal plane. In some embodiments, the cutaneous nasion can be a saddle point of the nose. For example, in the sagittal plane, the cutaneous nasion can be the furthest point of the fronto-nasal notch on the cutaneous profile.

In some embodiments, orientation information can be used to aid in locating points. For example, if a patient's head was tilted rather than in a neutral position, the AI/ML model should preferably have this information during training and/or during deployment, or the information can be used in a preprocessing step to orient the facial scan or model. In some embodiments, sensor data (e.g., accelerometer, magnetometer, and/or gyroscope data) collected during capture of the patient's face can be used to determine the orientation of the facial scan or model with respect to gravity or another reference axis.

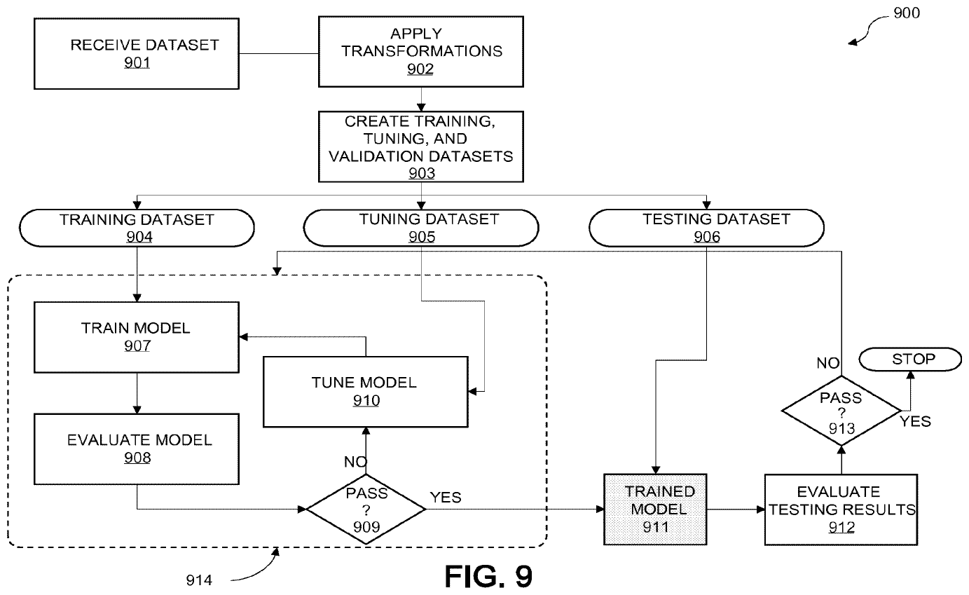

As discussed above, in some embodiments, an AI/ML model can be used to determine reference points. FIG. 9 is a flow chart for training an artificial intelligence or machine learning model according to some embodiments. The process 900 can be run on a computing system. At block 901, the system may receive a dataset that includes Eigenfaces, Fisherfaces, or the like. In some embodiments, some or all of the dataset can be annotated to indicate various landmarks, primary points, secondary points, and so forth. In some embodiments, additional information can be included, such as gender, age, sex, race, ethnicity, conditions (e.g., malocclusion), and so forth. Including such data can during a training process can result in a trained model that can more accurately determine features of patients by considering factors that can influence facial features. At block 902, one or more transformations may be performed on the data. For example, data may require transformations to conform to expected input formats, for example Eigenfaces, Fisherfaces, and so forth can be converted particular size, colors can be removed, and so forth. In some embodiments, the data may undergo conversions to prepare it for use in training an AI or ML algorithm. For example, categorical data may be encoded in a particular manner. Nominal data may be encoded using one-hot encoding, binary encoding, feature hashing, or other suitable encoding methods. Ordinal data may be encoded using ordinal encoding, polynomial encoding, Helmert encoding, and so forth. Numerical data may be normalized, for example by scaling data to a maximum of 1 and a minimum of 0 or −1. These are merely examples, and the skilled artisan will readily appreciate that other transformations are possible. At block 903, the system may create, from the received dataset, training, tuning, and testing/validation datasets. The training dataset 904 may be used during training to determine features for forming a model. The tuning dataset 905 may be used to select final models (e.g., final weights) and to prevent or correct overfitting that may occur during training with the training dataset 904, as the trained model should be generally applicable to a broad spectrum of patients. The testing dataset 906 may be used after training and tuning to evaluate the model. For example, the testing dataset 906 may be used to check if the model is overfitted to the training dataset. The system, in training loop 914, may train the model at block 907 using the training dataset 904. Training may be conducted in a supervised, unsupervised, or partially supervised manner. According to some embodiments, supervised training may be preferable as it may be desirable to identify reference points generally known to those of skill in the art. At 908, the system may evaluate the model according to one or more evaluation criteria. For example, the evaluation may include determining how often the model correctly determines the locations of primary points, secondary points, landmarks, and so forth. At 909, the system may determine if the model meets the one or more evaluation criteria. If the model fails evaluation, the system may, at 910, tune the model using the tuning dataset 905, repeating the training at block 907 and evaluation at block 908 until the model passes the evaluation at 909. Once the model passes the evaluation at block 909, the system may exit the model training loop 914. The testing dataset 906 may be run through the trained model 911 and, at block 912, the system may evaluate the results. If the evaluation fails, at block 913, the system may reenter training loop 914 for additional training and tuning. If the model passes, the system may stop the training process, resulting in a trained model 911. In some embodiments, the training process may be modified. For example, the system may not use a tuning dataset 905. In some embodiments, the model may not use a testing dataset 906.

While described with regard to detecting landmarks, primary points, secondary points, and so forth, it will be appreciated that the same or a similar process can be used for making other determinations. For example, the model can be trained to identify a potential condition such as malocclusion. For example, a model can be trained using a set of tagged images that show patients with different types of malocclusions or no malocclusion. For example, images can be tagged according to the Angle classification method, with Class I indicating normal molar alignment, Class II indicating overjet or overbite, and Class III indicating underjet or underbite.

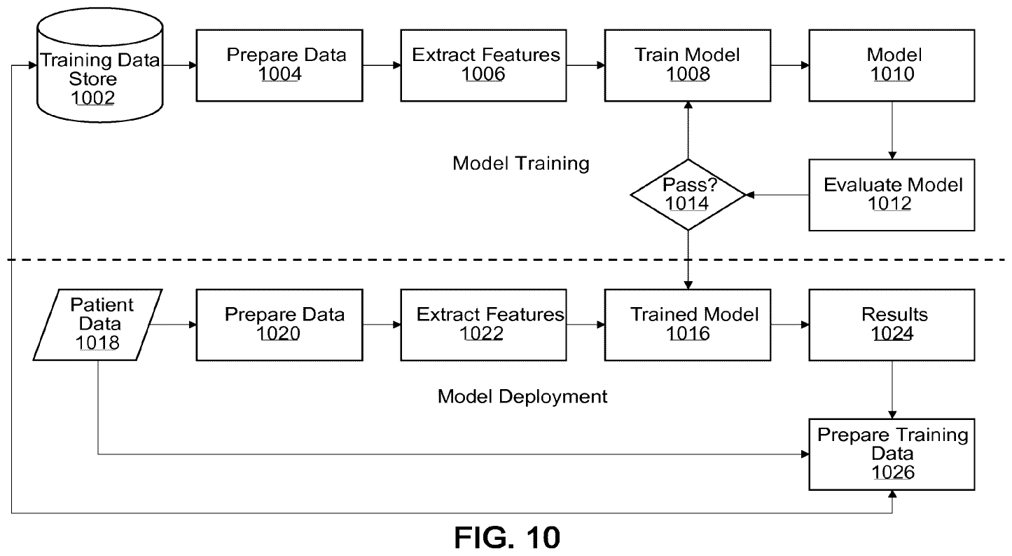

FIG. 10 illustrates an example process for training and using an AI/ML model according to some embodiments. The process depicted in FIG. 10 can be used for various purposes, such as to identify primary points, identify secondary points, determine conditions the patient may have (e.g., malocclusion), and so forth. Training data store 1002 can store data for training the model. For example, training data store 1002 can store facial images, facial scan data, 3D models, low-dimensional representations such as Eigenfaces, Fisherfaces, or the like (e.g., weights), and so forth. In some embodiments, the training data can be annotated to include information for training the model. For example, images, facial scans, 3D models, and the like can be annotated to indicate the locations of landmarks, primary points, secondary points, and so forth. At block 1004, a system can be configured to prepare the training data if it was not previously prepared for use in training a model. Preparing the training data can include performing one or more normalization procedures, standardization procedures, and so forth. For example, image data, facial scan data, 3D model data, and so forth can be normalized to a particular size, colors can be removed or normalized, orientation can be adjusted, and so forth. At block 1006, the system can extract features from the training data and, at block 1008, can train the model using the training data to produce model 1010. At block 1012, the system can evaluate the model to determine if it passes one or more criteria (e.g., success criteria for correctly identifying landmarks or points on the faces of patients). At decision point 1014, if the model fails, the system can perform additional training. If, at decision point 1014, the model passes, the system can make available trained model 1016, which can be the model 1010 after training is complete.

The trained model 1016 can be used to evaluate a particular patient. Patient data 1018 can relate to a specific patient for whom the outputs (e.g., locations of landmarks, primary points, secondary points, etc.) of the trained model 1016 are desired. At block 1020, the system can prepare the data, for example as described above in relation to the stored training data. At block 1022, the system can extract features from the prepared user data. The system can be configured to feed the extracted features to the trained model 1016 to produce results 1024.

In some embodiments, the patient data 1018 (and optionally the results 1024) can be stored for training. At block 1026, the system can prepare the patient data 1018 and the results 1024 for use in training. Preparing the data can include, for example, anonymizing the data, for example if a name or patient ID was associated with the data. In some embodiments, the system can store the prepared data in training data store 1002. In some embodiments, the prepared data can be stored, additionally or alternatively, in another database or data store. In some embodiments, the system can retrain the model periodically, continuously, or whenever an operator indicates to the system that the model should be retrained. Thus, in some embodiments, the trained model 1016 can evolve over time, which can result in, for example, improved determinations over time as the model is trained on additional data. In some embodiments, the patient data 1018 may not be stored in the training data store 1002. In some embodiments, once a model is trained, it may not be updated, or may undergo only occasional updating. For example, regulatory requirements may limit changes to the model.

As described above, extraction can include receiving a facial scan data for a patient, generating a representation (e.g., an Eigenface or Fisherface representation) of the patient, and applying an AI/ML model to the representation to determine the locations of various reference points, landmarks, etc. In some embodiments, alternative approaches can be used. For example, in some embodiments, a system can be configured to determine the locations of reference points without generating a low-dimensional representation of the patient, for example by working directly with the facial scan data. In some embodiments, the facial scan data can undergo some processing prior to being processed by an AI/ML model. For example, in some embodiments, the AI/ML model can be configured to use three-dimensional facial scan data. In some embodiments, the AI/ML model can be configured to use one or more two dimensional projections of the patient's face. The AI/ML model can be trained and deployed in a manner similar to that described above, but instead of using Eigenface representations (or another low-dimensional representation) as training data and instead of using Eigenface representations (or another low-dimensional representation) of a patient for model deployment, facial scan data can be used for training and model deployment. The facial scan data can be tagged in a manner similar to or the same as that used for training a model that works using Eigenface representations.

In some embodiments, multiple models can be used. For example, different models can be trained using different data. For example, one model can be trained using frontal two dimensional images while another model can be trained using profile images. In some cases, a model can be trained using depth information and another model can be trained using image information. These are merely examples, and the particular inputs for different models can vary to include different poses, different facial expressions, different types of data (e.g., image data and/or depth data, which can be in two dimensions or three dimensions), and so forth.

In some embodiments, using multiple models can provide several benefits. For example, the locations of reference points can be determined more accurately in some embodiments. In some embodiments that use multiple models, transfer learning can be used, which can enable training the models together. For example, a model trained to determine reference points using head on facial images can be repurposed into another model to recognize reference points in profile images. For example, in the case of computer vision, lower layers of an AI/ML model typically recognize edges, shapes, and so forth. Higher layers of the AI/ML can recognize particular reference points. Thus, for example, the layers that recognize edges and shapes could be repurposed while the higher layers could be trained to recognize reference points in profile images. Similar approaches could be applied to recognizing reference points using depth data, for example. These are merely examples, and transfer learning can be used in a wide variety of ways as will be understood by those of skill in the art.

### Combination Phase

After determining the locations of reference points, a system can be configured to combine the points in ways that are useful for dental treatment planning. For example, reference points can be used to determine planes, lines, or other points that are useful in dental treatment planning.

In a combination phase, points can be associated with one another to describe axes, planes, landmarks, or other surfaces or features of interest. For example, two reference points can be associated with one another to form a line. As another example, three reference points can be associated with one another to form a plane. In some embodiments, more than three reference points can form a subset and can be associated with one another and can define a surface having a shape that goes through every reference point in the subset. In some embodiments, various restrictions can be imposed on the shape of the surface. For example, without any restrictions an infinite number of surfaces can be defined that go through the reference points in the subset, but nearly all of these surfaces are anatomically non-sensical. Thus, restrictions can be imposed that limit curvature of the surface, slopes of the surface, and so forth. In some embodiments, restrictions can vary depending upon the patient. For example, restrictions can ensure that a surface representing the patient's cheek does not appear sunken in. However, some patients may have cheeks that are sunken in, and the restrictions may be modified accordingly. In some embodiments, restrictions can be adjusted automatically based on information about the patient, such as sex, gender identity, age, ethnicity, race, and so forth.

In some embodiments, reference points can be associated with other reference points or vectors. For example, reference points can be associated with earth's gravitational axis. In some embodiments, reference points can be associated with an orthonormal reference frame.

In some embodiments, the reference points, landmarks, and so forth can be used to generate a model of the patient's face. The model can comprise, for example, a mesh or point cloud that represents the patient's face.

In some embodiments, the combination phase can determine the axis-orbital plane, a plane passing through the condylar points and one of the left infraorbital point, the right infraorbital point, or an average position of the left and right infraorbital points. In some embodiments, the combination phase can determine the Camper plane, defined as a plane passing through the tragion and the subnasal point. In some embodiments, the combination phase can determine the tragion-nose wing plane.

In some embodiments, other reference planes can include the median sagittal plane passing through the nasion, the sub-nasal point, and a point situated equidistant from the condylar points. A reference axis can include the bicondylar axis, defined by the line passing through the left condylar point and the right condylar point. A reference axis can include the bi-pupillary axis, defined by a line passing through the left pupillary point and the right pupillary point. In some embodiments, the lower face contour can be used to generate one or more reference axes, contours, and so forth. In some embodiments, the lower face contour can be defined by a path that goes through the tragions, the gonions, and the gnathion. In some embodiments, an aesthetic line can connect the tip of the nose and the pogonion.

### Analysis Phase

In the analysis phase, various measurements relevant to dental treatment planning can be determined. For example, a system can be configured to determine the mandibular angle (e.g., an angle formed by the junction at the gonion of the posterior border of ramus and the inferior border of the body of the mandible). The mandibular angle can be calculated as the angle between the tragion-gonion line segment and the gonion-gnathion line segment. In some cases, the mandibular angle can indicate a growth defect. In some cases, normalization of the mandibular angle can be a goal of surgical intervention and can inform a surgical procedure. As another example, in some embodiments, the system can determine ratios of different stages of the face. For example, the system can be configured to determine a ratio between the trichion-ophryon, the ophryon-subnasal, and/or the subnasal-gnathion. The choice of a new vertical dimension of occlusion can be facilitated by the study of these relationships between the different stages of the face. The positioning of the dental arches can be adjusted to harmonize the lower level (e.g., the distance between the gnathion and subnasal points) with the other levels.

In another example, the system can determine one or more ratios (e.g., aesthetic ratios) that can inform a dental treatment plan. In some embodiments, the system can be configured to determine how far forward or backward the lips should be positioned. For example, the lips can be positioned based on the Ricketts line. The positioning of the dental arches can play a significant role in the positioning of the lips. For example, the mandibular arch position can significantly impact how far forward or back the lower lip is placed. Analysis of this aesthetic ratio (and/or other ratios) can be beneficial for dental treatment planning.

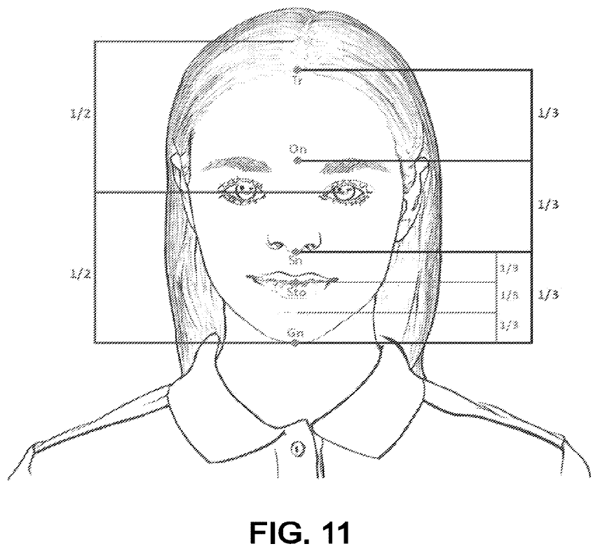

FIG. 11 illustrates an example of various ratios that can be relevant for dental treatment and planning. For example, the distance from the top of the head to the midpoint of the eyes can preferably be about the same as the distance from the midpoint of the eyes to the gnathion. As another example, the distance from the subnasal point to the stomion point can preferably be about the same as the distance between the stomion point and a point halfway between the stomion point and the gnathion point. As another example, the trichion-ophryon distance can be about the same as the ophryon-subnasal distance and the subnasal-gnathion distance.

Once the characteristic points and planes have been found using the methods described herein, a single coordinate system can be created for the dental arch models, facial capture system (e.g., smartphone, tablet, laptop, or the like), and the characteristic points and planes. For example, the device used for facial capture (e.g., phone, tablet, camera, etc.) can have one or more sensors built in or attached thereto (e.g., accelerometer, gyroscope, magnetometer, and/or the like) which can be used for orientation determination and the creation of a single orthonormal coordinate system. The characteristic points and planes can have locations within a coordinate system defined using orientation data associated with the facial capture device. The maxillary and mandibular dental arches can be defined according to a second, different coordinate system. After registration of the dental arches with the facial scan data, the maxillary and mandibular dental arches can be defined in the same coordinate system as the characteristic points and planes.

In some embodiments, multiple coordinate systems can be used. For example, in some embodiments, the mandibular arch can have its own coordinate system. For example, a separate coordinate system for the mandibular arch can facilitate relatively simple transformations, rotations, etc. of the mandibular arch.

During the analysis phase, it can be important to have a model of the patient's face that is well-defined. For example, the model preferably has high resolution and represents the patient's entire face. Analysis can be compromised if relevant points either could not be identified or were misidentified during the extraction phase. In some embodiments, a model can include reference points. In some embodiments, a model can be a point cloud or mesh generated based on the reference points or using other methods as described herein, for example a deformable mask.

In some embodiments, alternative approaches can be used rather than or in addition to the three-phase and two-phase approaches described above. For example, in some embodiments, static characteristics of the patient can be determined using a deformable mask (also referred to as a deformable model).

The use of a deformable mask can be appealing for a variety of reasons. For example, deformable masks can have well-defined reference points, rigs for manipulation, and so forth. Advances in augmented reality have enabled real-time or nearly real-time use of deformable masks. For example, a deformable mask can be readily overlaid onto a capture of a patient, live or after facial capture. Augmented reality solutions can offer surface detection, image recognition, face recognition, and so forth, enabling a deformable mask to be easily applied to a patient's face. In some embodiments, an AR solution can include motion tracking, which can be important for dynamic characteristic determination, as described below. A deformable mask can be deformed to more closely represent an actual patient's face. Since the deformable mask can have well-defined reference points, reference point recognition steps can be eliminated or simplified considerably. In some embodiments, the pre-defined reference points of the deformable mask can be used to associate reference points, planes, landmarks, surfaces, and so forth with features of the patient's face. In some embodiments, bone structure, dental models, and so forth can be used to refine the deformable mask, to define limits of motion, and so forth. In some embodiments, custom rigs can be developed that are of particular relevance for dental treatment planning. For example, for dental treatment planning, it can be important to have a high level of control of the positioning of the teeth.

In some embodiments, a custom AR solution can be provided. In some embodiments, an AR solution can make use of existing libraries, applications, application programming interfaces (APIs), and so forth. For example and without limitation, an AR solution can make use of Vuforia, Unity AR Foundation, Wikitude, EasyAR, ARToolKit, ARKit, ARCore, and/or the like. Some of these solutions may work across platforms (e.g., on different operating systems, different central processing unit (CPU) architectures, and so forth). In some embodiments, AR solutions can be specific to an operating system, CPU architecture, graphical processing unit (GPU) architecture, and so forth. Visualization can be carried out using a variety of technologies such as, for example and without limitation, OpenGL, OpenGL ES, Metal, WebGL, Vulkan, and so forth.

In some embodiments, facial scan data can be used to directly generate a 3D model of the patient's face. In some embodiments, a model can be generated based on, for example, determined reference points as described above. Such models can be referred to as primary models. For example, the primary model can be constructed from the depth information associated with a facial scan. In some embodiments, a texture for the model can be determined from a captured facial image, a facial scan, or both. Preferably, the facial image data is captured at the same time as the depth data, although this is not strictly necessary.

In some embodiments, the primary model can be a point cloud or mesh that represents the patient's face and may or may not include texture. However, the primary facial model can be missing some information. For example, limitations of the capture technology can result in missing data, erroneous data, and so forth. In some cases, hair or other obstructions can result in errors in the primary model. Thus, it may be desirable not to use the primary model for further analysis. However, the primary model may be sufficiently detailed so that it can be used for generating a secondary model. The secondary model can be, for example, a deformable model or mask. The deformable model or mask can be a mathematical model that includes one or more controllable parameters. In some embodiments, a primary model may not be used. As described above, AR technology can be used to deform a deformable mask to fit a patient's face, which can obviate any need to separately create a primary model. In some embodiments, augmented reality solutions can be used to superimpose characteristic points and planes on the deformable model.

In some embodiments, it may be preferable to use a secondary model even if there are no apparent issues with the primary model. For example, a secondary model can be at least somewhat standardized and can have well-defined reference points, landmarks, manipulations, and so forth. Software can be optimized to work with secondary models. Thus, in some cases, the secondary model can be manipulated with fewer errors and with more realistic manipulations than the primary model.

In some embodiments, the secondary model can be defined at least in part by representations or locations of points of interest (e.g., landmarks, primary points, secondary points, etc.). In some embodiments, one or more transformations can be applied to the secondary model, for example to cause the secondary model to more closely represent the patient's face. Such transformations can include, for example, adjusting the positions of the ears, eyes, nose, lips, and so forth. In some embodiments, the jaw can be moved backward or forward, and/or left or right. In some embodiments, cheek roundness, nose width, nose shape, and so forth can be adjusted.

In some embodiments, in a first transformation, the secondary model can be superimposed onto the primary model or onto the patient's face. In some embodiments, the secondary model can be superimposed onto the patient's face (e.g., the facial capture or a live view of the patient). In some embodiments, the fitting may not be exact. In some embodiments, the secondary model can be deformed to minimize the difference between the primary model and the secondary model (or between the patient's face and the secondary model), for example by minimizing the mean squared error or the mean absolute error. For example, if outliers are strongly disfavored, the mean squared error can be used as it is more sensitive to outliers, while if the severity of an outlier is roughly linear with the absolute error, mean absolute error may be a better measure.

Various methods can be used to deform the secondary model. Deforming the secondary model can be performed using, for example and without limitation, mesh interpolation, skeletal animation, cage deformation, or any combination of these methods. Such methods are known to those of skill in the art. The mesh interpolation method, also referred to as linear mesh morphing, can include creating a series of intermediate shapes between an initial mesh and a target mesh. The intermediate shapes can be obtained by linearly interpolating vertex coordinates between the initial mesh and the target mesh. This approach enables the transformation of the secondary model in a smooth manner and without major deformations. For example, mesh interpolation can use linear transforms such as enlargement, reduction, and/or rotation.

The skeletal animation method can deform the mesh in a controlled manner using a skeleton or rig. The bones of the skeleton can be associated with vertices or groups of vertices of the mesh, and the displacement of the bones can cause deformation of the associated vertices. In some embodiments, the skeletal animation method may be preferable for accurately modeling the movements of a patient's face.

With the cage deformation method, an initial mesh can be “wrapped” in a deformable cage. Deforming the cage can result in modification of the shape of the initial mesh. For example, as the vertices of the cage are moved, the initial mesh can be deformed accordingly. This method can be especially attractive when more drastic transformations are desired.

In some embodiments, the deformable model or mask can include or have associated therewith one or more points on the mesh that can be associated with reference points for use in augmented reality applications. In some embodiments, the mesh can be animated. For example, the mesh can be overlaid onto the face of a patient and can deform to match the patient's facial movements, expressions, or both.

In some embodiments, various data processing steps can be performed. For example, the dental arches can be matched to the primary face or secondary face as described herein. In some embodiments, the secondary model can be matched to the primary model or the facial scan. In some embodiments, the dental arches can be co-registered with the secondary model. In some embodiments, a system can be configured to orient the deformable model with gravity. In some embodiments, the system can determine the glabella, the farthest part above the nose and at the beginning of the forehead. In some embodiments, after determining the glabella, the suborbital point can be found. After locating the suborbital point, the system can locate the condylar point. Such a process can be repeated for the left and right sides of the patient's face. In some embodiments, data about motion of the patient's jaw can be used to refine the positioning of the condylar point, as described below with reference to dynamic characteristics.

Any of the approaches described above can be performed with or without including the patient's teeth (e.g., using a facial model or an orofacial model). Determining reference points, lines, and planes, for example, can be performed without necessarily having knowledge of the patient's teeth. However, co-registering the patient's teeth (e.g., dental model) and the patient's face can have many benefits. For example, the positioning of the patient's teeth can significantly impact the positioning of the patient's lips. As another example, the patient's teeth can restrict movement of the patient's jaw (e.g., the jaw cannot continue closing once the patient's maxillary and mandibular teeth collide).

In the following figures, various examples for generating representations of faces, training AI/ML models, and analyzing facial capture, dental models, or both (e.g., orofacial models) are illustrated. It will be appreciated that these are merely examples. Not all steps may be required, and steps may be performed in a different order than the order depicted in the following figures. In some embodiments, the processes described below can be modified to include additional steps, such as orienting and/or co-registering a facial scan, facial model, dental model, etc.

The following descriptions and accompanying drawings make reference to images. However, it will be appreciated that the processes described below can be applied to various types of data. For example, the processes below can be applied to facial scans (e.g., 3D facial scans), facial models (e.g., 3D facial models), two-dimensional images, depth data, and so forth, unless context would clearly dictate otherwise.

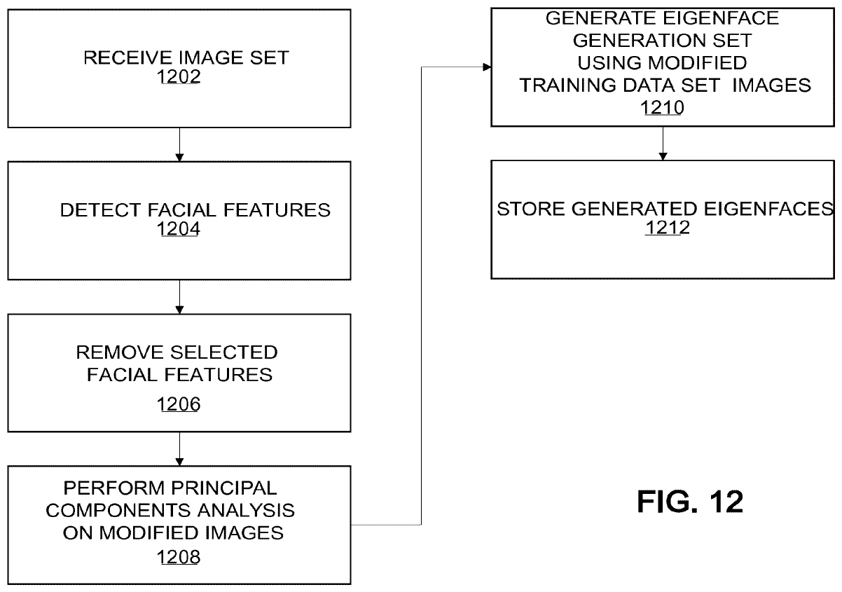

FIG. 12 is a flowchart that illustrates an example process for generating low-dimensional representations according to some embodiments. The low-dimensional representations can comprise, for example Eigenfaces, Fisherfaces, or the like. At block 1202, a computer system can receive a set of images for generating low-dimensional representations. In some embodiments, the images may be standardized (e.g., all in color or all in grayscale, all with the individual depicted from the same distance and positioned within the frame at the same location, etc.). In some embodiments, the images may not be standardized, and processing can be performed (e.g., resizing, rotation, deskewing, cropping, color normalization, etc.) before further steps are carried out. At block 1204, the system can detect features that are of lesser importance for dental treatment planning (e.g., eyebrows, parts of the outer ear other than the tragus, etc.). At block 1206, the system can remove a subset of facial features that are of lesser importance for dental treatment planning. For example, the system can blur features, place solid colors over features, and so forth. In some embodiments, a blur area, solid colored area, etc., can be standardized in size, location, and/or the like, so that such modifications do not vary from image to image. At block 1208, the system can perform principal components analysis on the modified images. At block 1210, the system can generate a set of Eigenfaces (or the like). The generated set of Eigenfaces can form a basis set that can be used to represent patients. In some embodiments, linear discriminant analysis can be used, for example when using Fisherfaces (or a similar approach). At block 1212, the system can store the Eigenfaces (or the like) for future use, for example when determining features of a particular patient.

In some embodiments, the process shown in FIG. 12 can be carried out for a single set of images that can include individuals of varying ages, genders, sexes, races, ethnicities, and so forth. In some embodiments, the process shown in FIG. 12 can be carried out multiple times to generate multiple sets of Eigenfaces (or the like). For example, the process could be carried out for different groups of people that tend to share common characteristics. For example, it may be beneficial to have different sets of Eigenfaces for men and women, different sets for children, adolescents, and adults, and so forth. In such cases, when performing analysis on a particular patient, a set of Eigenfaces (or the like) can be selected based on particular characteristics of the patient. As discussed above, in some embodiments, the image set can comprise 2D images, such as 2D projections of the facial scan data. In some embodiments, the 2D images can be from specific angles (e.g., head on, profile, etc.). In some embodiments, the 2D images can be, for example, an “unrolled” image determined from a facial capture. For example, a 2D image can be prepared by performing a projection operation similar to those used for making maps of earth. In some embodiments, rather than two dimensional images, the process can be performed using facial captures (which can comprise, for example, three dimensions). In some embodiments, full facial captures (e.g., capturing the entire head) can be used, while in other embodiments, only partial captures (e.g., from the left ear to the right ear) may be used.

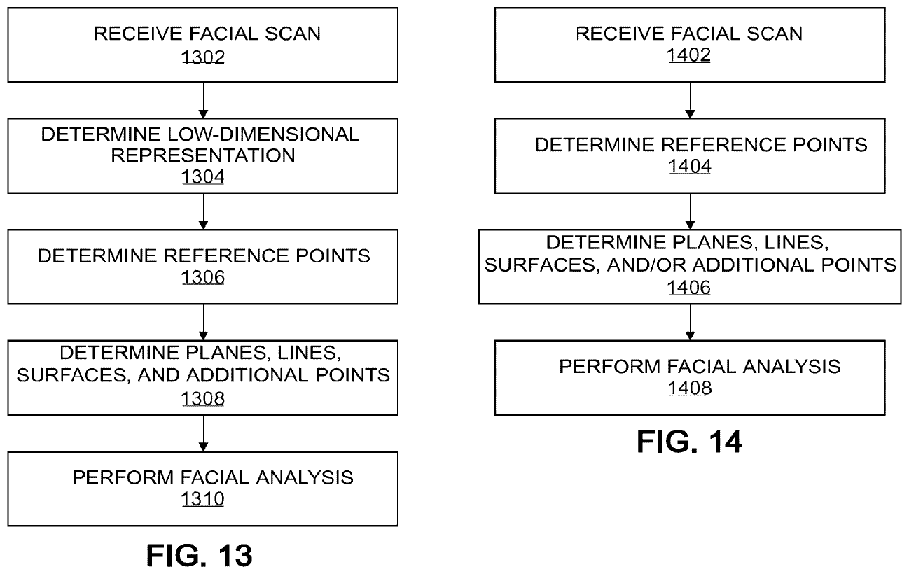

FIG. 13 is a flowchart that illustrates an example process according to some embodiments. The process illustrated in FIG. 13 uses Eigenfaces (or a similar approach) to represent a patient. The process illustrated in FIG. 13 can be run on a computer system. At block 1302, the system can receive a facial scan of a patient. In some embodiments, the system may perform further steps directly using the facial scan. In some embodiments, the system may generate one or more two dimensional projections, as described above, and further steps may be performed using a two-dimensional projection. In some embodiments, multiple two-dimensional projections can be used, as described in more detail below. At block 1304, the system can determine a low-dimensional representation, e.g., an Eigenface representation, Fisherface representation, and so forth. At block 1306, the system can determine reference points, for example using an AI/ML model configured to determine reference points from a low-dimensional representation of the patient's face. At block 1308, the system can determine any combination of lines, planes, surfaces, or additional points (e.g., points that were not determined at block 1306). The lines, planes, surfaces, or additional points can be determined based on, for example, reference points determined at block 1306. At block 1310, the system can perform facial analysis. For example, the system can determine one or more ratios as described in more detail herein. In some embodiments, at block 1310, the system can determine a condition affecting the patient, such as malocclusion.

While described above with reference to a single low-dimensional representation, it will be appreciated that in some embodiments, multiple low-dimensional representations can be used. For example, blocks 1304, 1306, and 1308 can be performed multiple times, for example once for each received image or for multiple views generated from a facial capture. In some embodiments, the steps carried out at blocks 1306, 1308, and 1310 can take the different low-dimensional representations into account. For example, at block 1306, different AI/ML models trained to recognize features using different low-dimensional representations (e.g., one using frontal views and one using profile views), can provide different results for the locations of features. In some embodiments, the system can incorporate a feedback or cooperative mechanism to reach agreement between the models. In some embodiments, an average location can be used (e.g., an average of locations determined by different models for a particular reference point). In some embodiments, if several models (e.g., more than two) are used, the location of a reference point can be governed by consensus. For example, a reference point can be identified once a defined number of models agree on the location of the reference point. For example, agreement can be reached when a defined number of models agree on the location of a reference point to within a defined limit (e.g., within 0.1 mm, within 0.5 mm, within 1 mm, within 2 mm, within 3 mm, etc.). In some embodiments, a limit can vary depending on the particular reference point, for example based on the importance of the reference point for dental treatment planning, the difficulty of locating the reference point, and so forth.

Similar techniques can be applied to other embodiments herein. For example, similar or the same techniques can be applied to the process depicted in FIG. 14.

FIG. 14 is a flowchart that illustrates an example process according to some embodiments. Unlike the process depicted in FIG. 13, a low-dimensional representation of a patient's face may not be generated. At block 1402, a system can receive a facial scan. In some embodiments, the facial scan can be used directly. In other embodiments, two dimensional projections as described above can be generated and further steps can be carried out using the two-dimensional projections. In some embodiments, the system can generate a simplified facial model (e.g., a 3D mesh or point cloud) that is generated based on the facial scan data. At block 1404, the system can determine reference points, for example using an AI/ML model. At block 1406, the system can determine any of lines, planes, surfaces, or additional points, for example based on the reference points determined at block 1404. At block 1408, the system can perform facial analysis as described above.

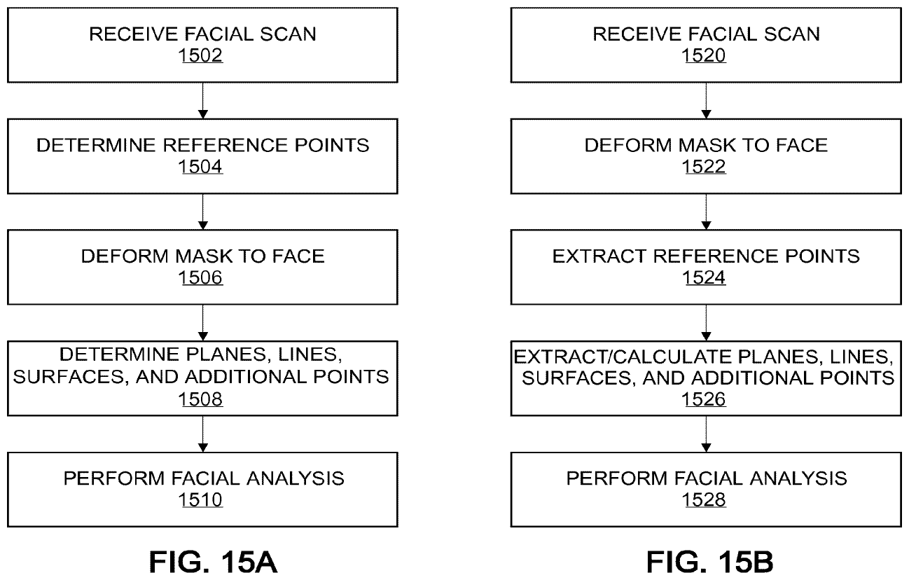

FIG. 15A is a flowchart that illustrates an example process according to some embodiments. The process depicted in FIG. 15A utilizes a deformable mask. At block 1502, a system can receive a facial scan of a patient. At block 1504, the system can determine one or more reference points based on the facial scan. At block 1506, the system can deform the deformable mask to the face. The location of the reference points can be used to aid in positioning and/or deforming the mask with respect to the patient's face. This approach can be appealing because, for example, it may help to ensure that points of the mask that are most relevant for dental treatment planning are accurately mapped to the patient's face. However, as described below with respect to FIG. 15B, such an approach may not be used and a simpler process may instead be used. At block 1508, the system can determine various landmarks, planes, lines, surfaces, additional points, and so forth using the deformable mask. At block 1510, the system can perform facial analysis (e.g., lip position with respect to Ricketts line, ratios, etc., as described herein).

FIG. 15B is a flowchart that illustrates another example process according to some embodiments. At block 1520, a system can receive a facial scan. At block 1522, the system can deform a deformable mask to the patient's face (e.g., based on the facial scan). Advantageously, in contrast to FIG. 15A, this can be done without generating a separate facial model, determining reference points, etc. Rather, surface detection, facial recognition, feature recognition, and so forth as provided in some AR solutions. At block 1524, the system can extract reference points from the deformable mask. As discussed above, a deformable mask can have well-defined reference points. Thus, in some embodiments, reference points can be extracted readily without additional detection or determination processes. At block 1526, the system can extract and/or calculate landmarks, planes, lines, surfaces, and/or additional reference points. Advantageously, such extractions and/or calculations can be based on information already contained within the deformable mask. At block 1528, the system can perform facial analysis as described herein (e.g., lip position with respect to Ricketts line, ratios, etc., as described herein).

FIGS. 13-15B describe processes that utilize facial scan data but which do not utilize dental model data. As discussed above, it can be beneficial to include dental model data for various reasons. For example, if dental model data is included, it can place limits on the deformable model, for example to avoid collisions that can occur if the jaw is allowed to close too much. It can be important to include teeth when developing a dental treatment plan. For example, while the approaches above might reveal a dental condition or facial imbalance, without information about the teeth, a practitioner may struggle to develop a treatment plan.

### Dynamic Characteristics

While static information can provide useful insights, it can be important to also consider the dynamic movements of a patient (e.g., movements of the patient's jaw, teeth, and/or face). Dynamics can be important for both functionality and aesthetics. For example, the positioning of the patient's teeth can be optimized to achieve functional results (e.g., chewing without causing excessive wear, biting without undue difficulty) and/or aesthetic results (e.g., appearance when smiling).

In some embodiments, the patient's movements can be recorded directly, for example using a camera or other motion capture device and one or more markers placed on the patient (e.g., markers on the patient's forehead, chin, and so forth). However, as discussed above, the use of markers or specialized equipment can be challenging, due to difficulty in using such equipment, the cost of acquiring such equipment, and so forth. In some embodiments, markers may not be used. In some embodiments, the movements can include movements of the patient's face. In some embodiments, the movements can include movements of the patient's jaw. In some embodiments, the movements can include movements of the patient's teeth. In some embodiments, motion capture can be performed using a smartphone or other device equipped with depth sensing technology. In some embodiments, a series of still images (with or without depth information) can be used to determine dynamic movements of the patient's skeletal features, skin, and so forth. In some embodiments, video (with or without depth information) can be used to determine dynamic movements. As described above, in some embodiments, a deformable mask can be used for dynamic analysis.

In some embodiments, a large number of movements can be represented in a facial capture. In some embodiments, various methods can be used to improve tracking of the mandibular movement without markers, for example by training an AI/ML model to detect movements. Motion detection using an AI/ML model will be readily understood by those of skill in the art. In some embodiments, an AI/ML model can be trained to select points of a deformable model that are the most relevant to use to animate the dental arch models, the mandible, and so forth. The appropriate selection can depend on a variety of factors, for example patient morphotype, laxity of the skin, age, sex, gender, race, ethnicity, weight, and so forth. In some embodiments, only some factors can be considered. In some embodiments, such considerations may not be taken into account and a model can instead represent a general or average animation, although it can be beneficial for a model to be able to be used to accurately represent specific patients.

In some embodiments, a motion tracking model can be an AI/ML model. In some embodiments, the motion tracking model can be trained to identify motion of a patient's jaw, motion of a patient's lips, and so forth. Generally, such a model can be trained in a manner similar to that described above. In some embodiments, the model can be configured for time series analysis.

In some embodiments, a training data set for training a motion tracking model can include reference movements obtained from motion capture using optical, optoelectronic, accelerometer markers (fixed or movable), and so forth. In some embodiments, markers can be fixed on the maxillary arch, the mandibular arch, or both. In some embodiments, tracking can be improved based on a plurality of registrations with real markers. Such an approach can enable the selection of parts of a deformable mask, point cloud, mesh, or the like that are most useful for animation. This approach can enable accurate jaw tracking in actual patients without the use of markers based on facial motion. For example, an AI/ML model can be initially trained using reference movements. Transfer learning can be used in training the model to track jaw motion without the use of markers. For example, the weights determined using markers can serve as a starting point for weights for a model that does not rely on markers.

In some embodiments, a motion tracking model may not be trained using motion capture data as described above. For example, a motion tracking model can be trained using captured video, captured image frames, etc., without the use of markers.

In some embodiments, a motion tracking model can be trained using tagged data (e.g., in a supervised manner). In some embodiments, other training approaches can be used, such as partially supervised, unsupervised, and so forth.

In some embodiments, an AI/ML model (e.g., as described above) can use facial capture data and dynamic data to determine optimal deformations or manipulations to apply to a secondary model. For example, if a deformable mask is used to represent a patient, movements of the deformable mask can be selected to more closely match the actual movements of the patient.

### Orofacial Visualization and Manipulation

As described above, in some cases, it can be important to consider the face and teeth together. For example, while facial analysis can provide information that is helpful for dental treatment planning, if the teeth are not fully considered, it can be difficult to determine how to manipulate the teeth in order to achieve desired facial characteristics. For example, a static characteristic determination process as described above may reveal that the lips are too far forward or too far back from the Ricketts line (a line extending from the tip of the nose to the tip of the chin), but this information alone may be insufficient for developing a treatment plan.

As discussed above, in some embodiments, an AI/ML model can be trained to identify issues and recommend approaches to dental treatment. In some embodiments, such identifications and recommendations can be based solely on facial analysis. In some embodiments, the AI/ML model can be trained using an orofacial model (e.g., a model that represents both the teeth and the patient's face, for example by combining facial scan data, a deformable mask, or the like and a dental model (or dental models) for the patient).

While an orofacial model can be analyzed by an AI/ML model to at least partially determine a dental treatment plan, it can be important for a practitioner to be able to visualize the patient and the results of the dental treatment plan. In some embodiments, a practitioner may follow a recommended dental treatment plan created by a computer system using the AI/ML model. In some embodiments, a practitioner may wish to alter the dental treatment plan or develop their own dental treatment plan. Accordingly, it can be important to provide systems and methods for visualizing an orofacial model. In some embodiments, systems and methods herein can enable manipulation of the orofacial model, for example by moving the teeth, extending or reducing the mandible, and so forth.

A practitioner may conclude that movement of the teeth is warranted to improve appearance. If a dental model (or models) is co-registered with a facial model, the practitioner can better determine how to adjust the teeth to achieve desired results.

As discussed above, various methods exist for generating a facial model. For example, a facial model can be a deformable mask generated based at least in part on facial scan data. As another example, a facial model can be a mesh or point cloud model based on facial scan data. In some embodiments, the facial scan data itself can be directly used as a model. By applying the static and dynamic analysis methods described herein, a model can be created.

While the above disclosure can be used to generate a model of the patient's face that accurately reflects the patient's structure and motion, it can be important that the teeth are correctly oriented in the model. As described above, a dental model can be created using an intraoral scan, x-ray technology, dental impressions or molds, and so forth.

In some embodiments, the placement of the dental model with respect to the facial model (for example, a primary model or a secondary model) can be based on measurements performed by a practitioner, for example using the techniques described in U.S. Pat. No. 10,265,149. For example, trackers can be affixed to the patient and to a wand, and information about particular points on the patient's teeth can be collected. However, specialized equipment can be used in this approach.

In some embodiments, automatic registration can be performed. For example, if a profile x-ray of the patient or a 3D x-ray scan of the patient is available, it can be used to register the facial and dental models as described above.

The co-registered facial model and dental model can be presented to a practitioner for viewing and/or manipulation in a user interface.

Over the last several years, augmented reality (AR) and virtual reality (VR) solutions have been developed. These solutions can be available in the form of applications, libraries, application programming interfaces (APIs), and so forth. In some cases, AR solutions can utilize motion tracking, surface detection, image recognition, or any combination of these as well as other features.

AR solutions can include, for example and without limitation, Vuforia, Unity AR Foundation, Wikitude, EasyAR, ARToolKit, ARKit, and ARCore. Some solutions may work across platforms, for example on computers, smartphones, tablets, headsets, and so forth running various operating systems such as Windows, macOS, Linux, Android, IOS, and iPadOS, among others, while others may be designed to operate on a limited number of devices or operating systems.

Augmented reality solutions can offer many advantages for dental treatment planning. For example, surface detection and image and face recognition can be combined with real-time rendering, which can enable the association of characteristic points and planes with features of the face. In some embodiments, a three-dimensional model (or multiple models) of the dental arches can be superimposed on the face. In some embodiments, the 3D model(s) of the dental arches can be placed in a same orthonormal reference frame as the face. In some embodiments, the placement of the dental arch models can be used to provide reference points for characteristic points and planes.

In some embodiments, three-dimensional renders can include the patient's face, teeth, and characteristic points and planes. In some embodiments, such three-dimensional renders can be generated using a 3D API such as, for example and without limitation, OpenGL, OpenGL ES, Metal, WebGL, Vulkan, and so forth.

In some embodiments, an orofacial model can comprise a deformable model. There are several techniques that can be employed to manipulate the deformable model. In some embodiments, blendshapes can be used. In some embodiments, geometric morphing can be used.

Blendshapes (also referred to as morph targets) can be deformable three-dimensional models that have been pre-built to represent different facial expressions such as smiling, frowning, blinking, and so forth. In some embodiments, developers can use these models to create facial animations by combining different blendshapes. In some embodiments, such an approach can enable real-time or nearly real-time animation. For example, a model can deform in real-time or nearly real-time to provide a live animation of the facial movements of a patient.

In some embodiments, geometric morphing can be used. Geometric morphing is a morphing technique that changes the geometry of a 3D model. In some embodiments, geometric morphing can be performed in real time or nearly real time. Geometric morphing uses a deformable 3D mesh that can be adjusted according to the shape of the user's face. The 3D mesh can be divided into triangles, and each triangle can be deformed to follow the patient's facial movements.

Whether blendshapes or geometric morphing are used, it can be important to find nodes of a deformable mask that will enable accurate animation of the dental arches, the face, and so forth. For example, it can be important that the mandible moves in a manner consistent with a patient's actual jaw motion. In some embodiments, the most relevant nodes can be located primarily at the level of the chin and/or the lower and/or lateral edges of the mandible.

In some embodiments, various steps can be taken to ensure more realistic motion. For example, the deformable model can be adjusted to more closely represent the patient when the patient's mouth is closed. In some embodiments, blendshapes can present a particular challenge because they are generally designed and calibrated based on facial expressions (e.g., smiling, frowning, surprised, and so forth) rather than mandibular positions, dental contacts, and so forth, which can generally be more important for developing a dental treatment plan. In some embodiments, a system can determine a position of the face (e.g., a position of the mandible) when the teeth are in the occlusion position (e.g., when the mandibular and maxillary teeth are touching). This position can be different from a resting position of the patient. For example, at rest or in a neutral position, the teeth typically are not in contact and the mandible is slightly lower.

Reproducing dental contacts can be important for dental treatment planning, as poor alignment of the teeth when the mouth is fully closed can lead to significant issues, such as premature wear, lack of contact between teeth, and so forth. For example, rear mandibular and maxillary molars may contact while more forward mandibular and maxillary molars may not come into contact.

It can be important that the dental model and the facial model (which together can form an orofacial model) be co-registered with a high degree of accuracy, as even small deviations from a patient's true anatomy can have a significant impact on dental contacts.

In some embodiments, pre-made blendshapes can be used. For example, a third party can provide blendshapes to reflect facial expressions. In some embodiments, custom blendshapes can be used for dental treatment planning. For example, custom blendshapes can be created for low amplitude movements such as lateral movements and propulsions.

In some embodiments, a system can be configured to provide collision detection. A collision detection algorithm can ensure that no mesh penetration occurs, or mesh penetration occurs only in a clinically acceptable manner. For example, teeth, which are generally rigid and non-deformable, may not penetrate one another. However, soft tissues can be deformed, so some amount of mesh penetration may be permitted.

In some embodiments, animation of the orofacial model may not be smooth. For example, there can be jumps or other defects in the animation. In some embodiments, smoothing techniques can be applied to ensure smooth motion.

In some embodiments, a user interface can display a distance map. The distance map can show, for example, the proximity between different meshes. For example, a distance map can show how close the mandibular teeth are to the maxillary teeth. Methods for determining teeth contact are discussed in U.S. Pat. No. 10,582,992.

In some embodiments, condylar points attached to the mandibular arch can be used to draw lines, arcs, and so forth and/or to indicate values such as, for example, condylar slopes, Bennett angle, and so forth. In some embodiments, condylar slopes can be analyzed based at least in part on a protrusion movement. In some embodiments, a left Bennett angle can be determined based at least in part on a right laterotrusion. In some embodiments, a right Bennett angle can be determined based at least in part on a left laterotrusion. These are merely examples, and the skilled artisan will readily appreciate that analysis of dynamic characteristics can be used to determine many parameters that can be of use for dental treatment planning.

In some embodiments, a user interface can enable an orofacial model to be deformed over time. For example, such an animation may depict a patient in their original state (e.g., prior to treatment). In some embodiments, the animation can show a final result. In some embodiments, the animation can show one or more intermediate results, such as how the patient will appear one month after beginning treatment, three months after beginning treatment, six months after beginning treatment, and so forth.

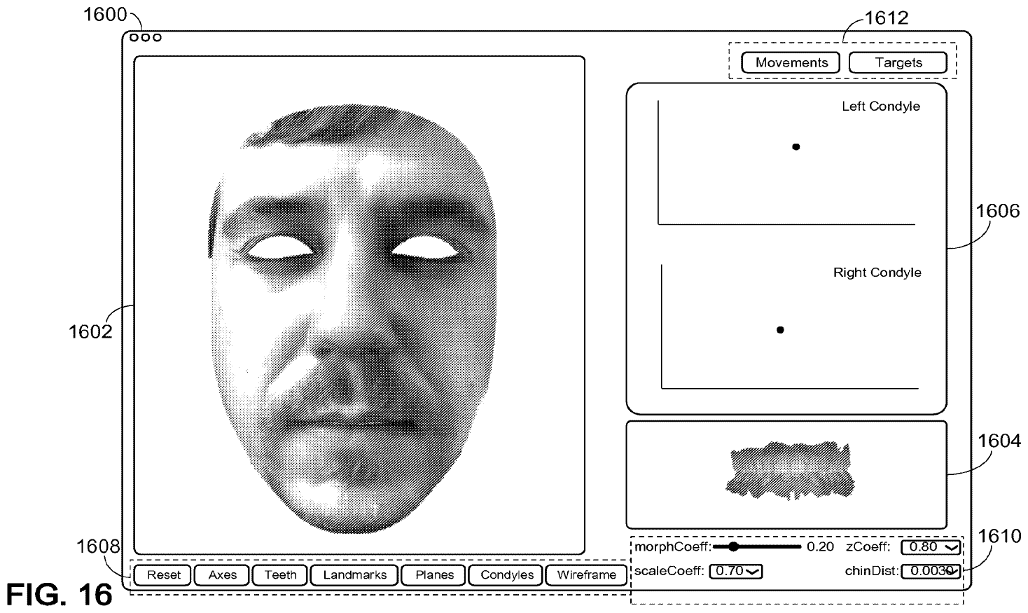

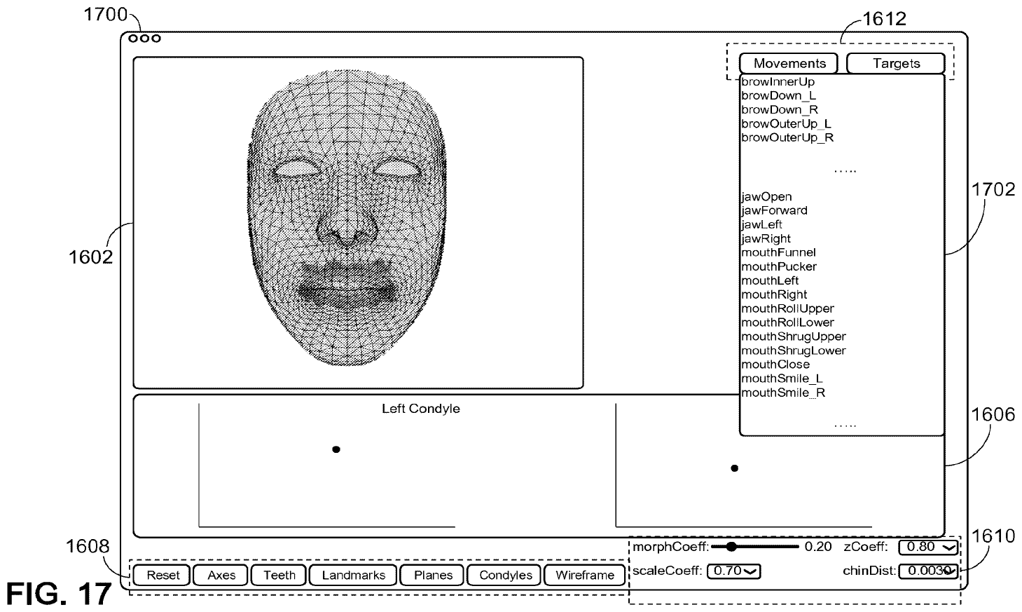

In FIGS. 16 and 17, the interface may display points that differentiate between different areas and which may be used for model kinematics. For example, some points may be associated with the chin while others may be associated with the lip contour. In some embodiments, the software may be configured to automatically identify points. In some embodiments, points may be manually placed, or a user may refine or correct recommended automatic placement of the points.

In FIG. 16, a user interface 1600 has a main view 1602, a tooth view 1604, a plot view 1606, buttons 1608, adjustment coefficients 1610, and dropdowns 1612. The buttons 1608 may be used to alter the display. For example, a reset button may change views to their initial positions, and an axes button may be used to toggle the display of axes in the main view of the user interface. A teeth button may be used to enable and disable the display of teeth in the main view, and a landmarks button may be used to enable and disable the display of landmarks in the main view 1602 such as, for example, showing or hiding the vertices used in the computation of the mandible position (determined at least in part from the chinDist coefficient discussed below), upper lip landmarks, and so forth. The planes button can be used to toggle the display of the two principal planes in the main view 1602. A condyles button may be used to enable or disable the display of condyles in the main view 1602. A wireframe button may be used to toggle between a wireframe view and other views, such as displaying the captured face of the patient.

In some embodiments, the plot view can be configured to show various plots. For example, the plot view can be used to illustrate movement of the left condyle, right condyle, interincisal point, and so forth. In some embodiments, plots can be shown from various views, such as a frontal view or a sagittal view.

It will be appreciated that a user interface may have more or fewer features and may implement features in different ways (for example, checkboxes may be used to enable or disable the display of various components such as axes, planes, condyles, and so forth) while still enabling substantially the same uses.

In FIG. 17, the user interface 1700 permits the user to perform various actions that may be beneficial in fitting the patient's teeth to the patient's face. For example, a user may use the morph targets list 1702 to apply various transformations to the patient's face. For example, the morph targets may be used to open and close the jaw, to bring the jaw forward or back, or to move the jaw left or right. The user may adjust the morphCoeff value within adjustment coefficients 1610 to determine the intensity of the morph (for example, how far to open a jaw or how far to bring the jaw forward). Further, a user may adjust the zCoeff, scaleCoeff, and chinDist variables within the adjustment coefficients 1610 to control the position of the teeth in relation to the face. For example, zCoeff may be manipulated to change the distance of the teeth from the lips, scaleCoeff may be used to control the size of the teeth relative to the patient's face, and chinDist may be used to alter how the mandible moves with the mouth, for example by changing which vertices are used to compute the movement of the teeth.

The morph target list 1702 may also be used to, for example, cause the patient to smile or exhibit another facial expression, which may be beneficial when determining an optimal placement of the patient's teeth.

The facial and tooth capture data may further be used as inputs as part of a process of designing a smile of the patient by altering the alignment and positioning of the patient's teeth or artificial teeth.

In some embodiments, the user interface can be configured to allow the practitioner to adjust the positioning of the teeth within the patient's mouth. For example, the practitioner can adjust the maxillary teeth, the mandibular teeth, all teeth, subsets of teeth, or individual teeth. In some embodiments, the practitioner can adjust the pose, facial expression, etc. of the patient (e.g., a model representing the patient) to evaluate the placement of the teeth.

In some embodiments, the user interface can be configured to enable a user to record and/or replay motion. In some embodiments, the user interface can be used to show contact relations or an occlusal surface between mandibular and maxillary teeth. In some embodiments, color-coding can be used to indicate distance between maxillary and mandibular teeth. In some embodiments, the user interface can enable visualization and/or generation of an occlusal reference sphere (e.g., Monson sphere) and/or Monson curve. In some embodiments, the user interface can enable a user to display and/or alter a functionally generated surface. The functionally generated surface can indicate an envelope of function defined by dental arch motion.

In some embodiments, the user interface can be configured to enable a user to view and/or adjust various aesthetic parameters. For example, in some embodiments, a user can adjust a vertical dimension of occlusion. In some embodiments, such adjustments can be limited by the known bone structure of the patient, positioning of the teeth, and so forth. In some embodiments, the user can manipulate the positioning of the teeth. In some embodiments, the user can manipulate the bone structure, for example to shorten or lengthen the mandible in the case of a patient who suffers from underjet or overjet.

### Computer Systems

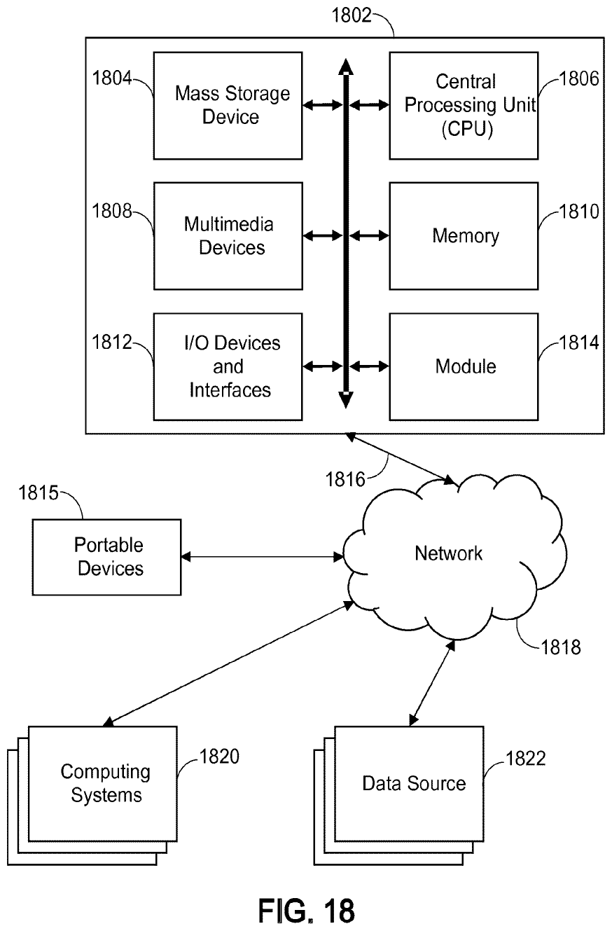

FIG. 18 is a block diagram depicting an embodiment of a computer hardware system configured to run software for implementing one or more embodiments disclosed herein. Unless contacts clearly dictates otherwise, references to computing systems 1820 may also refer to portable devices 1815.

In some embodiments, the systems, processes, and methods described herein are implemented using a computing system, such as the one illustrated in FIG. 18. The example computer system 1802 is in communication with one or more computing systems 1820 and/or one or more data sources 1822 via one or more networks 1818. While FIG. 18 illustrates an embodiment of a computing system 1802, it is recognized that the functionality provided for in the components and modules of computer system 1802 may be combined into fewer components and modules, or further separated into additional components and modules.

The computer system 1802 can comprise a module 1814 that carries out the functions, methods, acts, and/or processes described herein. The module 1814 is executed on the computer system 1802 by a central processing unit 1806 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 1802 includes one or more processing units (CPU) 1806, which may comprise a microprocessor. The computer system 1802 further includes a physical memory 1810, such as random-access memory (RAM) for temporary storage of information, a read only memory (ROM) for permanent storage of information, and a mass storage device 1804, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 1802 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 1802 includes one or more input/output (I/O) devices and interfaces 1812, such as a keyboard, mouse, touch pad, and printer. The I/O devices and interfaces 1812 can include one or more display devices, such as a monitor, that allows the visual presentation of data to a user. More particularly, a display device provides for the presentation of GUls as application software data, and multi-media presentations, for example. The I/O devices and interfaces 1812 can also provide a communications interface to various external devices. The computer system 1802 may comprise one or more multi-media devices 1808, such as speakers, video cards, graphics accelerators, and microphones, for example.

The computer system 1802 may run on a variety of computing devices, such as a server, a Windows server, a Structure Query Language server, a Unix Server, a personal computer, a laptop computer, and so forth. In other embodiments, the computer system 1802 may run on a cluster computer system, a mainframe computer system and/or other computing system suitable for controlling and/or communicating with large databases, performing high volume transaction processing, and generating reports from large databases. The computing system 1802 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 1802 illustrated in FIG. 18 is coupled to a network 1818, such as a LAN, WAN, or the Internet via a communication link 1816 (wired, wireless, or a combination thereof). Network 1818 communicates with various computing devices and/or other electronic devices. Network 1818 is communicating with one or more computing systems 1820 and one or more data sources 1822. The module 1814 may access or may be accessed by computing systems 1820 and/or data sources 1822 through a web-enabled user access point. Connections may be a direct physical connection, a virtual connection, and other connection type. The web-enabled user access point may comprise a browser module that uses text, graphics, audio, video, and other media to present data and to allow interaction with data via the network 1818.

Access to the module 1814 of the computer system 1802 by computing systems 1820 and/or by data sources 1822 may be through a web-enabled user access point such as the computing systems' 1820 or data source's 1822 personal computer, cellular phone, smartphone, laptop, tablet computer, e-reader device, audio player, or another device capable of connecting to the network 1818. Such a device may have a browser module that is implemented as a module that uses text, graphics, audio, video, and other media to present data and to allow interaction with data via the network 1818.

The output module may be implemented as a combination of an all-points addressable display such as a cathode ray tube (CRT), a liquid crystal display (LCD), a plasma display, or other types and/or combinations of displays. The output module may be implemented to communicate with input devices 1812 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 1802 may comprise a physical or logical connection established between a remote microprocessor and a mainframe host computer for the express purpose of uploading, downloading, or viewing interactive data and databases on-line in real time. The remote microprocessor may be operated by an entity operating the computer system 1802, including the client server systems or the main server system, an/or may be operated by one or more of the data sources 1822 and/or one or more of the computing systems 1820. In some embodiments, terminal emulation software may be used on the microprocessor for participating in the micro-mainframe link.

In some embodiments, computing systems 1820 who are internal to an entity operating the computer system 1802 may access the module 1814 internally as an application or process run by the CPU 1806.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 1802 may include one or more internal and/or external data sources (for example, data sources 1822). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Caché), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MongoDB Atlas, Amazon Aurora, Amazon DynamoDB, Amazon Redshift, Amazon ElastiCache, Amazon MemoryDB for Redis, Amazon DocumentDB, Amazon Keyspaces, Amazon Neptune, Amazon Timestream, or Amazon QLDB), a non-relational database, or a record-based database.

The computer system 1802 may also access one or more databases 1822. The databases 1822 may be stored in a database or data repository. The computer system 1802 may access the one or more databases 1822 through a network 1818 or may directly access the database or data repository through I/O devices and interfaces 1812. The data repository storing the one or more databases 1822 may reside within the computer system 1802.

### Additional Embodiments

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

1. A method for determining characteristics of a patient comprising:
receiving, by a computer system, facial scan data of a patient, the facial scan data comprising image data and depth data;
determining, by the computer system based on the facial scan data, a plurality of reference points;
determining, by the computer system, one or more reference points, lines, or planes; and
determining, by the computer system, one or more ratios relevant for dental treatment planning.

2. The method of claim 1, wherein the plurality of reference points comprises at least one of an infraorbital point, a condylar point, a pupillary point, a nose wing point, a subnasal point, a gnathion point, a trichion point, an ophryon point, a gonion point, a pronasal point, an upper lip point, a lower lip point, an ectocanthion point, a tragion point, a cutaneous nasion point, or a summit of a tragus angle.

3. The method of claim 1, wherein determining the plurality of reference points comprises:
generating, based on the facial scan data, a low-dimensional representation of a face of the patient; and
determining, using a reference point recognition model, one or more reference points.

4. The method of claim 3, wherein the low-dimensional representation is based on a two-dimensional projection of at least a part of the facial scan data.

5. The method of claim 3, wherein the low-dimensional representation is based on the depth data.

6. The method of claim 3, wherein the low-dimensional representation is based on the image data.

7. The method of claim 1, wherein determining the plurality of reference points comprises:
applying, by the computer system, a deformable mask to the facial scan data; and
deforming the deformable mask, wherein deforming the deformable mask comprises adjusting the deformable mask to reduce a difference between the deformable mask and the facial scan data.

8. The method of claim 1, wherein the facial scan data comprises motion information, wherein the method further comprises:
determining, by the computer system, dynamic characteristics of the patient.

9. The method of claim 8, wherein determining the dynamic characteristics comprises:
detecting, by a motion detection model, movement of a mandible of the patient.

10. The method of claim 1, further comprising:
receiving, by the computer system, a dental model of the patient; and
co-registering the dental model and the facial scan data.

11. The method of claim 10, wherein the dental model comprises a maxillary model and a mandibular model.

12. The method of claim 11, further comprising:
generating a facial model of the patient;
co-registering the dental model and the facial model; and
determining a range of motion limit for a mandible of the patient, the range of motion limit determined by determining a closure amount at which the maxillary model collides with the mandibular model.

13. The method of claim 1, further comprises:
determining, by the computer system, a condition associated with the patient.

14. The method of claim 3, wherein generating the low-dimensional representation comprises:
determining a set of Eigenfaces and a set of associated weights, wherein a face of the patient is described by a linear combination of Eigenfaces and their associated weights.

15. The method of claim 7, wherein deforming the deformable masks comprises one of or more of cage deformation, skeleton animation, or mesh interpolation.

16.-36. (canceled)

37. A system for determining characteristics of a patient comprising:
one or more processors; and
a non-volatile storage medium with instructions embodied thereon that, when executed by the one or more processors, cause the system to perform steps of:
receiving, by a computer system, facial scan data of a patient, the facial scan data comprising image data and depth data;
determining, by the computer system based on the facial scan data, a plurality of reference points;
determining, by the computer system, one or more reference points, lines, or planes; and
determining, by the computer system, one or more ratios relevant for dental treatment planning.

38.-72. (canceled)
